(19) United States
(12) Patent Application Publication
(10) Pub. No.: US 2007/0123224 A1
(43) Pub. Date: May 31, 2007

(54) Information processing method and system for preventing leakage of information from mobile phone

(75) Inventors: Soichi Nishiyama, Kawasaki (JP); Yoshiyuki Itoh, Kawasaki (JP); Yu Minakuchi, Kawasaki (JP); Yasuhiko Awamoto, Shinagawa (JP); Naoto Matsudaira, Shinagawa (JP); Fumio Horie, Shinagawa (JP); Yusuke Tohnai, Shinagawa (JP); Minoru Takezawa, Kawasaki (JP); Kazuo Taniguchi, Kawasaki (JP); Hiroshi Nezu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/338,649

(22) Filed: Jan. 25, 2006

(30) Foreign Application Priority Data
Oct. 7, 2005 (JP) 2005-294588

(51) Int. Cl. H04Q 7/38; H04Q 7/22; H04M 3/42

(52) U.S. Cl. 455/414.1

(57) ABSTRACT

This invention is to provide a technology for preventing information from being leaked from a mobile phone. For this purpose, this invention includes: receiving a request for data to select a calling destination from a first mobile phone capable of executing voice communication and data communication; identifying calling destination candidates registered in a data storage in association with a user of the first mobile phone by identification information other than telephone numbers of the calling destination candidates; and transmitting data to specify and select anyone of the identified calling destination candidates by the identification information other than the telephone numbers of the calling destination candidates, to the first mobile phone. Because the telephone number of the client is not sent to the mobile phone, the leakage of the client information is prevented, even if the mobile phone is stolen.

### TECHNICAL FIELD OF THE INVENTION

The present invention relates to an information leakage prevention technology.

### BACKGROUND OF THE INVENTION

The utilization of mobile phones in business increases, and personal mobile phones may also be used in business in some cases. When such a mobile phone is lost, client information of a company could flow out, and this will raise a problem.

In order to solve the problem, there exists a mechanism in which a server on the side of a telephone company is provided with a telephone directory, and the server transmits telephone directory data to a mobile phone, if necessary, and on receiving a calling request for a specific calling destination from the mobile phone, the server calls both of the mobile phone and the specific calling destination and connects them. This will enable to prevent leakage of the telephone directory or client information registered in an outgoing/incoming calling history by securely controlling an access to the telephone directory, even if the mobile phone is lost, and in addition, because the server calls both of the mobile phone and the specific calling destination, a trouble of dividing a telephone rate into an individual and a corporate may reduced, even if the mobile phone belongs to the individual.

Moreover, for example, in US 2002/0018547, there is provided a disclosure of a mechanism in which, on receiving an instruction of a change notice of a phone number, changer telephone directory information searching means acquires telephone directory information of a changer from backup data, registrant information extracting means extracts information of a registrant registered in the telephone directory, registrant telephone directory information searching means acquires registrant's telephone directory information from the backup data, phone number change target extracting means extracts the registrant of the telephone directory information in which the changer is registered, phone number changing means rewrites the changer's phone number existed in the telephone directory information of the registrant, and change notifying means transmits a mail of a change notice of a phone number to the registrant. However, the present publication relates to a telephone directory information change apparatus, which enables to mutually carry out an operation accompanying the change of the phone number by using the backup data of the data center, which backs up the telephone directory information of the mobile phone. Therefore, it cannot deal with the aforementioned problem.

In the aforementioned related arts, countermeasures against the information leakage are insufficient, and some of them are insufficient in incidental services. Especially, because telephone directory data should be transferred to a telephone company side, there is uncertainty in management on the telephone company side. Moreover, if such a mechanism that a target phone number is simply notified to the mobile phone on receiving a call is adopted, this results in the information leakage.

### SUMMARY OF THE INVENTION

Therefore, an object of the present invention is to provide a technology for preventing information from being leaked from a mobile phone.

Furthermore, another object of the present invention is to provide a telephone communication technology, which enables improvement of usability.

An information processing method according to a first aspect of the present invention includes: receiving a request for data to select a calling destination from a first mobile phone capable of executing voice communication and data communication; identifying calling destination candidates registered in a data storage in association with a user of the first mobile phone by identification information other than telephone numbers of the calling destination candidates; and transmitting data to specify and select anyone of the identified calling destination candidates by the identification information other than the telephone numbers of the calling destination candidates, to the first mobile phone.

Thus, because client data managed on a server side is also transmitted as the data, which can be specified and selected by the identification information other than the telephone number, the outflow of the telephone numbers can be prevented.

Moreover, the information processing method according to the first aspect of the present invention may further include: receiving, from the first mobile phone, a calling request including the identification information of the specified calling destination and a recording request via the data communication; securing a first port to carry out the voice communication with the first mobile phone, a second port to carry out the voice communication with a second phone relating to the specified calling destination, and a third port for recording; establishing a link for the voice communication with the first mobile phone to carry out the voice communication via the first port; establishing a link for the voice communication with the second phone to carry out the voice communication via the second port; relaying voice data received from the first mobile phone to the second phone via the first port, and relaying the voice data received from the second phone to the first mobile phone via the second port; and recording the voice data transmitted via the first and second ports by use of the third port. Even in such a call between two parties, it becomes possible to record a call by securing three ports.

Furthermore, an information processing method according to a second aspect of the present invention is an information processing method executed by a computer, to which a specific telephone number is assigned, and includes: receiving from a first phone a calling to a direct inward dial number; establishing a link of voice communication with the first phone; identifying a transfer destination telephone number corresponding to the direct inward dial number by using a user information table; carrying out a calling from the specific telephone number to the transfer destination telephone number; receiving acknowledgment of receipt from the second phone relating to the transfer destination telephone number; establishing a link for the voice communication with the second phone in response to receipt of the acknowledgment of receipt; and transmitting a guidance including information on a calling source as voice data to the second phone. Thus, the information on the calling source is notified to the second phone on a calling destination side, as the voice data, not as a calling source number notice, web page data or the like. Therefore, it is possible to lower a possibility of client information leakage of the calling source.

Moreover, in the second aspect of the present invention, the guidance may include a message requesting a predetermined dial tone multi frequency (DTMF) signal to be returned when the voice communication will be carried out with the first phone. Moreover, the information processing method according to the second aspect of the present invention may further include: receiving the predetermined DTMF signal from the second phone; and relaying the voice data received from the first phone to the second phone, and relaying the voice data received from the second phone to the first phone in response to receipt of the predetermined DTMF signal. Because this enables a user who uses the second phone on the calling destination side to make a telephone call with the client of the calling source after making preparations, usability can be improved.

Furthermore, in the second aspect of the present invention, the information processing method according to the second aspect of the present invention may further include: detecting that the predetermined DTMF signal is not received within a predetermined time after execution of the transmitting the guidance; transmitting a guidance indicating inaccessibility of the voice data to the first phone after the detecting; and disconnecting the link for the voice communication with the first phone. As stated, even if the second phone on the calling destination cannot receive the calling, and the calling is switched to, for example, an answering machine, an appropriate voice guidance can be transmitted to the first phone of the calling source.

It is possible to create a program for causing a computer to execute the information processing method according to this invention, and this program is stored in a storage medium or a storage device such as a flexible disk, a CD-ROM, an optical magnetic disk, a semiconductor memory, and a hard disk. Further, the program may be distributed as a digital signal through a network. Incidentally, intermediate processing results are temporarily stored in a storage device such as a main memory.

### BRIEF DESCRIPTION OF THE DRAWINGS

FIG. 1 is a diagram showing a system outline in an embodiment of the present invention;

FIG. 2 is a diagram showing one example of a session management table;

FIG. 3 is a diagram showing one example of a telephone directory data table;

FIG. 4 is a diagram showing one example of a history management data table;

FIG. 5 is a diagram showing one example of a user information table;

FIG. 6 is a flowchart showing a login processing;

FIG. 7 is a diagram showing one example of a login screen;

FIG. 8 is a diagram showing one example of a top menu screen;

FIG. 9 is a flowchart showing a processing when registering a telephone number in a telephone directory;

FIG. 10 is a diagram showing one example of a telephone directory registration screen;

FIG. 11 is a diagram showing one example of a registration completion screen;

FIG. 12 is a diagram showing a first part of a processing flow in a case where a calling is carried out from a registered mobile phone;

FIG. 13 is a diagram showing one example of a telephone directory list screen;

FIG. 14 is a diagram showing a second part of the processing flow in the case where the calling is carried out from the registered mobile phone;

FIG. 15 is a diagram showing one example of a transmission completion screen;

FIG. 16 is a diagram showing a third part of the processing flow in the case where the calling is carried out from the registered mobile phone;

FIG. 17 is a diagram showing a fourth part of the processing flow in the case where the calling is carried out from the registered mobile phone;

FIG. 18 is a diagram showing a fifth part of the processing flow in the case where the calling is carried out from the registered mobile phone

FIG. 19 is a diagram showing a sixth part of the processing flow in the case where the calling is carried out from the registered mobile phone;

FIG. 20 is a diagram showing a first part of a processing flow in a first example in a case where the calling is carried out from the registered mobile phone but is failed;

FIG. 21 is a diagram showing a second part of the processing flow in the first example in the case where the call is carried out from the registered mobile phone but is failed;

FIG. 22 is a diagram showing a processing flow in a second example in a case where the calling is carried out from the registered mobile phone but is failed;

FIG. 23 is a diagram showing a first part of a processing flow in a case where the registered mobile phone responds to a calling at receiving the calling from a general phone;

FIG. 24 is a diagram showing a second part of the processing flow in the case where the registered mobile phone responds to a calling at receiving the call from the general phone;

FIG. 25 is a diagram showing a first part of a processing flow in a case where the registered mobile phone cannot respond to a calling at receiving the call from the general phone;

FIG. 26 is a diagram showing a second part of the processing flow in the case where the registered mobile phone cannot respond to the calling at receiving the call from the general phone;

FIG. 27 is a flowchart of a calling processing from an outgoing/incoming call history;

FIG. 28 is a diagram showing one example of an outgoing/incoming call history screen;

FIG. 29 is a flowchart showing a processing for logout; and

FIG. 30 is a functional diagram of a computer.

### DETAILED DESCRIPTION OF THE PREFERRED EMBODIMENTS

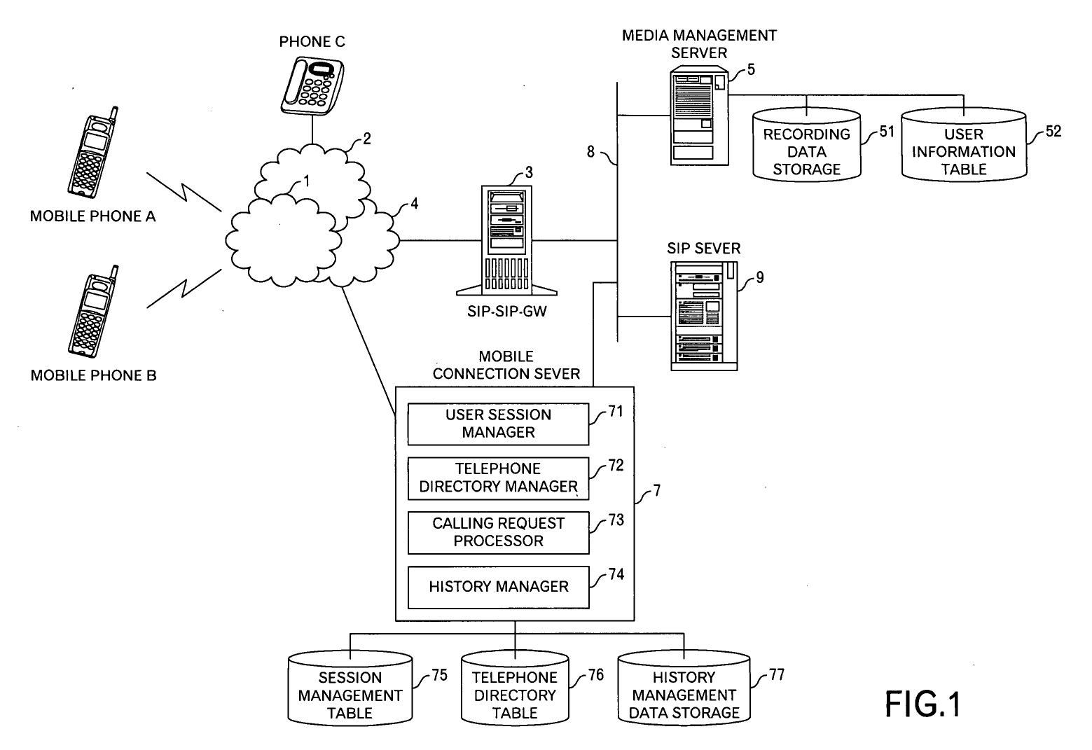

There will be provided a description of a system outline in one embodiment of the present invention with reference to FIG. 1. A network 1 is, for example, a mobile phone network, and voice and data communications are carried out. The network 1 is connected to a network 2 such as a public circuit network, and a network 4 such as the Internet. The network 1 is connected to a plurality of mobile phones (FIG. 1 only shows mobile phones A and B), which carry out wireless communication with anyone of plural base stations connected to the network 1. The mobile phone of the present embodiment is a wireless communication device having at least a web browser function and a voice communication function. In addition, a special client application to carry out a processing according to the present embodiment may be executed in the mobile phone. The network 2 is connected to plural phones (FIG. 1 only shows a phone C) having a voice communication function.

The network 4 is connected to a session initiation protocol (SIP)-SIP-gateway (GW) 3 and a mobile connection server 7 installed in the present embodiment. The SIP-SIP-GW 3 is connected to a media management server 5 and an SIP server 9 via a network 8. The mobile connection server 7 is also connected to the network 8. Voice data is exchanged between the networks 8 and 4, mainly via the SIP-SIP-GW 3. The normal data is usually processed in the mobile connection server 7, and necessary data is outputted to the media management server 5 or the like.

The media management server 5 has a teleceonference function, a voice data relay function, a voice recording function and the like, and manages a recording data storage 51 and a user information table 52. The SIP server 9 is a server, which carries out a communication control in accordance with the SIP. The mobile connection server 7 has a user session manager 71, a telephone directory manager 72, a calling request processor 73, and a history manager 74, and manages a session management table 75, a telephone directory data table 76, and a history management data storage 77.

In the aforementioned example, although there is provided an indication of a configuration example in which the network 4 is bridged to the network 8 via the SIP-SIP-GW 3 and the mobile connection server 7, it is possible to adopt a network configuration in which all the servers are connected to the network 4 and the network 8 is not used.

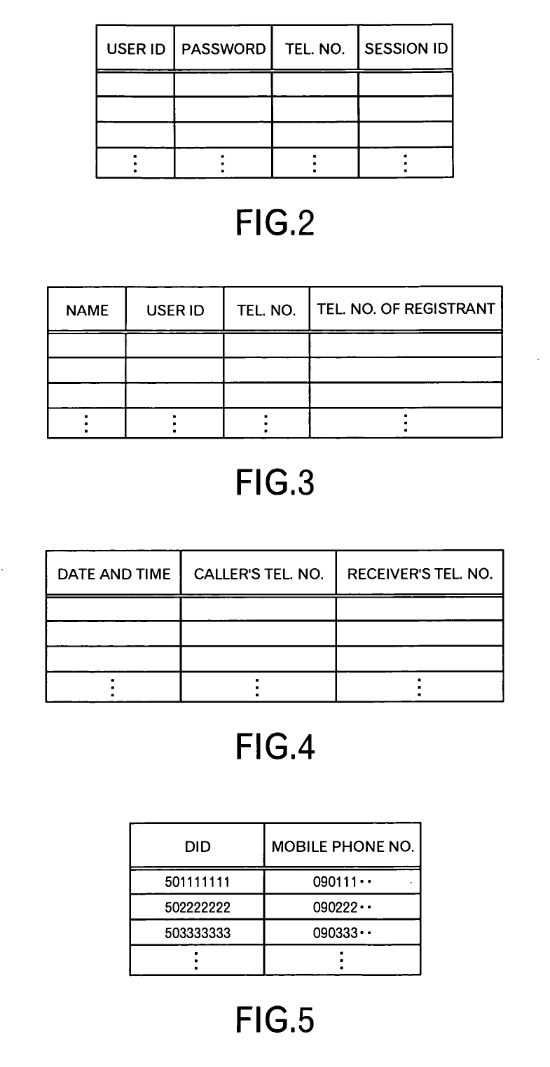

FIG. 2 shows a constitution example of the session management table 75. In the example of FIG. 2, a user ID, a password, a telephone number of the mobile phone, and a session ID are associated. The user ID, the password, and the telephone number of the mobile phone are registered beforehand. The session ID is assigned every login from the mobile phone, and registered in the session management table 75.

FIG. 3 shows a constitution example of the telephone directory data table 76. In the example of FIG. 3, a name, a user ID, a telephone number, and a telephone number of a registrant who has registered the name and the telephone number are associated. The name and the telephone number are registered in accordance with an instruction from the user. The user ID is uniquely generated and registered, when the registration instruction is received. The registrant's telephone number is extracted and registered, when the registration instruction is received.

FIG. 4 shows a constitution example of a history management data table stored in the history management data storage 77. In the example of FIG. 4, a calling date and time, a caller's telephone number, and a receiver's telephone number are associated. Incidentally, detailed history data is registered in the history management data storage 77, in addition to the history management data table. The detailed history data includes a caller's telephone number, a receiver's telephone number, presence or absence of recording, a calling receipt date and time, a calling start date and time, a calling end date and time, a calling time, success/failure of a call and the like.

FIG. 5 shows a constitution example of the user information table 52. In the example of FIG. 5, a direct inward dial (DID) number and a telephone number of the mobile phone are associated. In the present embodiment, the DID is assigned to each employee, and an incoming call is transferred to the mobile phone used by the employee. Incidentally, the telephone number of the phone other than the mobile phone may be registered.

The recording data storage 51 stores a recording data file generated by the recording function of the media management server 5. For example, the file is managed by a file name such as (date and time)—(telephone number of the mobile phone).

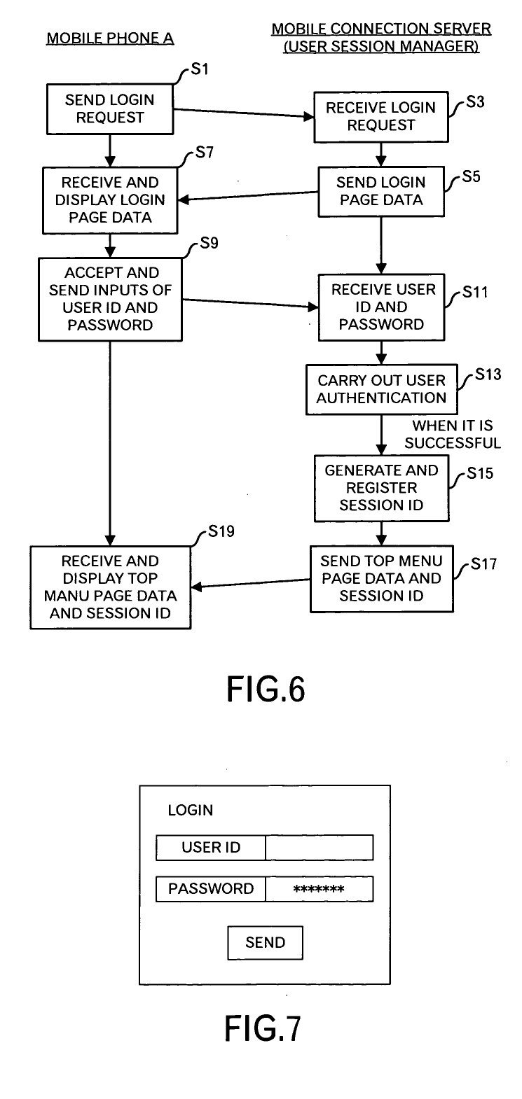

Next, there will be provided a description of a processing of the system shown in FIG. 1 with reference to FIGS. 6 to 29. First, a login processing will be described with reference to FIGS. 6 to 8. First, the user of the mobile phone A instructs a client application (web browser (hereinafter referred to simply as the browser) in some case, and a special client application in the other case, and the client application will be described as the browser hereinafter) of the mobile phone A to transmit a login request to the mobile connection server 7 (step S1). The user session manager 71 of the mobile connection server 7 receives the login request from the mobile phone A (step S3), and transmits login page data to the mobile phone A (step S5). The browser of the mobile phone A receives the login page data from the mobile connection server 7, and displays the data on a display device (step S7). For example, a screen shown in FIG. 7 is displayed. In a screen example of FIG. 7, input columns of the user ID and the password, and a send button are provided.

The user of the mobile phone A inputs the user's user ID and password, and clicks the send button. In this case, the browser of the mobile phone A accepts the inputs of the user ID and the password from the user, and transmits the user ID and password to the mobile connection server 7 (step S9). The user session manager 71 receives the user ID and the password from the mobile phone A (step S11), and searches the session management table 75 by using the received user ID, and reads out the password registered in association with the received user ID, and compares the received password with the read password to carry out a user authentication processing (step S13). When this user authentication fails, for example, the authentication failure is notified to the mobile phone A.

On the other hand, when the user authentication is successful, the user session manager 71 generates a session ID, registers the session ID in a pertinent record of the session management table 75 (step S15), and transmits top menu page data and the session ID to the mobile phone A (step S17).

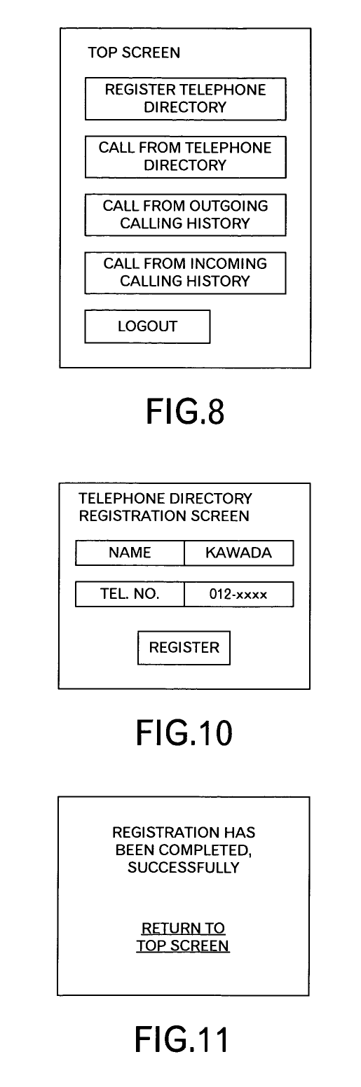

The browser of the mobile phone A receives the top menu page data and the session ID from the mobile connection server 7, stores them into a storage device such as a main memory, and displays a top menu screen on the display device (step S19). For example, a screen shown in FIG. 8 is displayed. In the screen example of FIG. 8, a “register telephone directory” button, a “call from telephone directory” button, a “call from outgoing call history” button, a “call from incoming call history” button, and a “logout” button are provided.

Hereinafter, a processing when this top menu screen is displayed, and any of the buttons is clicked will be described.

Incidentally, the session ID is generated in this manner, and is used as identification information to identify the mobile phone A between the login and logout.

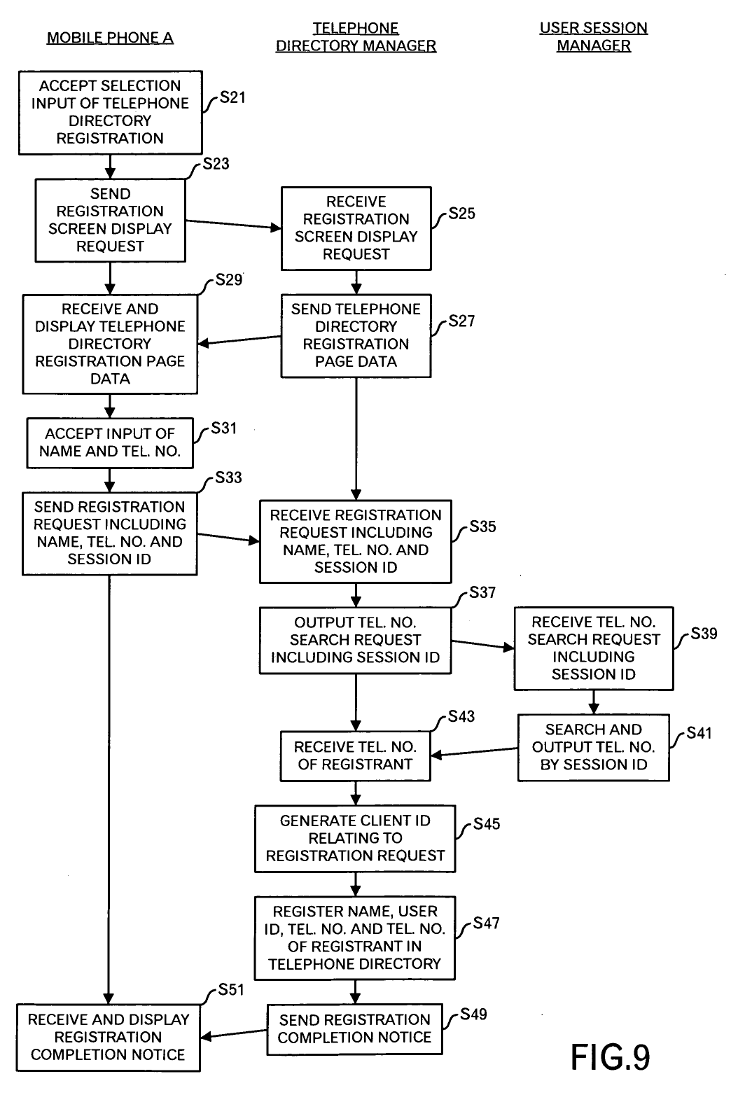

First, there will be provided a description of a processing in a case where the “register telephone directory” button is clicked with reference to FIGS. 9 to 11. When the user of the mobile phone A clicks the “register telephone directory” button on the top menu screen, the browser of the mobile phone A accepts the selection input of the telephone directory registration (step S21), and transmits a registration screen display request to the mobile connection server 7 (step S23). The telephone directory manager 72 of the mobile connection server 7 receives the registration screen display request from the mobile phone A (step S25), and transmits telephone directory registration page data to the mobile phone (step S27).

The browser of the mobile phone A receives the telephone directory registration page data from the mobile connection server 7 and displays the data on the display device (step S29). For example, a screen as shown in FIG. 10 is displayed. In the display example of FIG. 10, input columns of a registered client name and telephone number and a “register” button are provided.

The user of the mobile phone A inputs the name and the telephone number into the input columns, and clicks the “register” button. In this case, the browser of the mobile phone A accepts the inputs of the name and the telephone number (step S31), and transmits a registration request including the input name and telephone number and the held session ID to the mobile connection server 7 (step S33).

The telephone directory manager 72 of the mobile connection server 7 receives the registration request including the name, the telephone number, and the session ID from the mobile phone A (step S35), and stores the request in a storage device such as a main memory. Then, the telephone directory manager 72 generates a telephone number search request including the session ID and outputs the telephone number search request to the user session manager 71 (step S37).

The user session manager 71 receives the telephone number search request including the session ID from the telephone directory manager 72 (step S39), searches the session management table 75 by the session ID, reads out the telephone number registered in association with the session ID from the session management table 75, and outputs the telephone number to the telephone directory manager 72 (step S41).

The telephone directory manager 72 receives the telephone number corresponding to the session ID from the user session manager 71, and stores the telephone number in a storage device such as the main memory (step S43). Then, the telephone directory manager 72 generates the user ID of a client relating to the registration request (step S45), and stores a record including the received name, the generated user ID, the received client telephone number, and the registrant telephone number (telephone number received from the user session manager 71) into the telephone directory data table 76 (step S47). Then, it transmits registration completion notice page data to the mobile phone A (step S49). The browser of the mobile phone A receives the registration completion notice page data, and displays the data on the display device (step S51).

For example, a screen as shown in FIG. 11 is displayed. In the screen example of FIG. 11, a message stating, “Registration has been completed” and a link to return to TOP screen (top menu screen: FIG. 8) are provided.

Thus, by providing the telephone directory on a mobile connection server 7 side instead of the mobile phone, client information can be prevented from being accumulated in the mobile phone A, and this enables to prevent leakage of the client information.

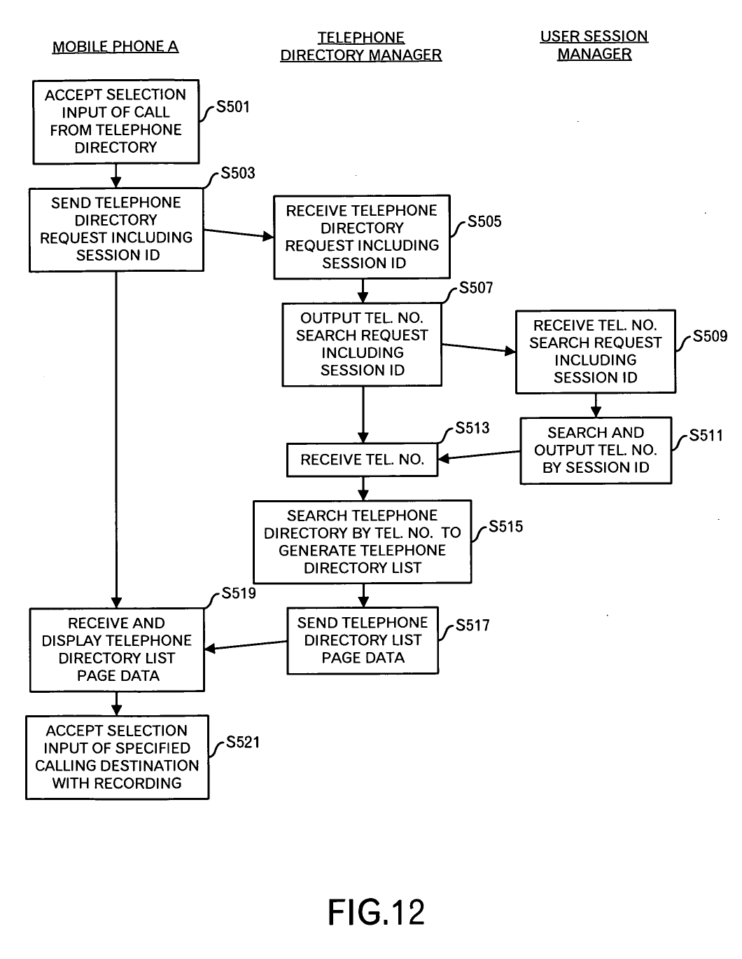

Next, there will be provided a description of a processing in a case where the “call from telephone directory” button is clicked in the top menu screen with reference to FIGS. 12 to 22. First, the user of the mobile phone A clicks the “call from telephone directory” button in the top menu screen. The browser of the mobile phone A accepts the selection input of the “call from telephone directory” from the user (step S501), and transmits a telephone directory request including the held session ID to the mobile connection server 7 (step S503).

When receiving the telephone directory request including the session ID from the mobile phone A (step S505), the telephone directory manager 72 of the mobile connection server 7 generates a telephone number search request including the session ID and outputs the request to the user session manager 71 (step S507). The user session manager 71 receives the telephone number search request including the session ID from the telephone directory manager 72 (step S509), searches the telephone directory data table 76 by the received session ID, reads out the telephone number registered in association with the session ID from the telephone directory data table 76, and outputs the read telephone number to the telephone directory manager 72 (step S511).

The telephone directory manager 72 receives the telephone number from the user session manager 71 (step S513), searches the telephone directory data table 76 by using the received telephone number as a registrant telephone number, extracts the name and user ID from the pertinent record, and generates a telephone directory list composed of the name and user ID (step S515). Then, the telephone directory manager 72 generates telephone directory list page data from the telephone directory list composed of the name and user ID, and transmits the data to the mobile phone A (step S517).

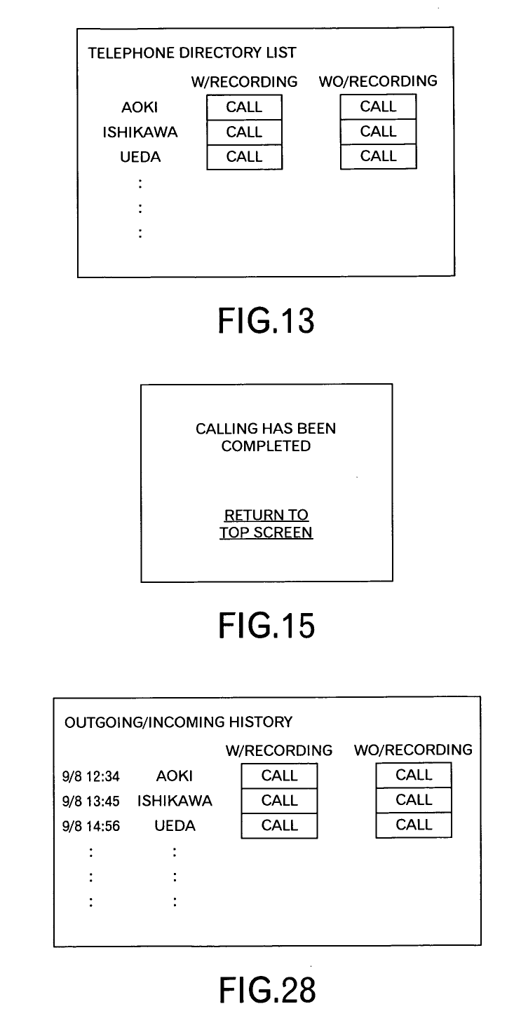

The browser of the mobile phone A receives the telephone directory list page data from the mobile connection server 7, and displays the data on the display device (step S519). For example, a screen as shown in FIG. 13 is displayed. In the screen example of FIG. 13, each name is provided with a corresponding call button without any recording and a corresponding call button with recording. The user ID itself is not displayed, and it is associated with the call button together with the corresponding recording flag (ON/OFF) in the telephone directory list page data.

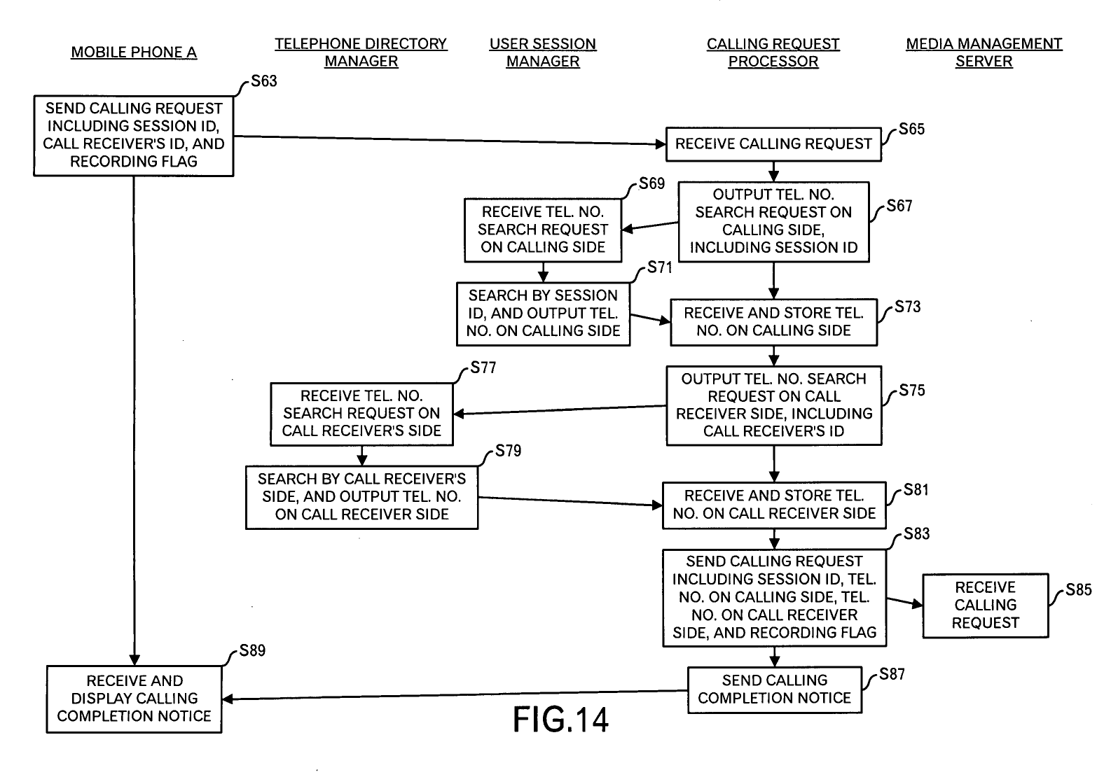

The user of the mobile phone A clicks the call button corresponding to the client name of the calling destination. In this case, the user clicks the call button in the column of “with recording” in a case where the recording should be carried out, and clicks the call button in the column of “without recording” in a case where the recording does not have to be carried out. Here, it is assumed that the call button of “with recording” is clicked with respect to a specific calling destination (here, phone C. However, the mobile phone B may also be selected). In this case, the browser of the mobile phone A accepts the selection input “with recording” with respect to the specific calling destination (step S61). The subsequent processing will be described with reference to FIG. 14.

The description shifts to the description of the processing of FIG. 14. The browser of the mobile phone A transmits, to the mobile connection server 7, a calling request including the session ID, the user ID of a call receiver relating to the selection and a recording flag (ON in this case) (step S63). The calling request processor 73 of the mobile connection server 7 receives the calling request including the session ID, the user ID of the call receiver and the recording flag (ON) from the mobile phone A, and stores the calling request into a storage device such as the main memory (step S65). Furthermore, the calling request processor 73 outputs the telephone number search request on a calling side, including the received session ID to the user session manager 71 (step S67). The user session manager 71 receives the telephone number searching request on the calling side, including the session ID from the calling request processor 73 (step S69). Then, the user session manager 71 searches the session management table 75 by the session ID, reads out a telephone number on the calling side, and outputs the telephone number on the calling side to the calling request processor 73 (step S71).

The calling request processor 73 receives the telephone number on the calling side from the user session manager 71, and stores the telephone number into a storage device such as the main memory (step S73). Furthermore, the calling request processor 73 outputs a telephone number search request on a call receiver side, including the receiver's user ID (step S75). The telephone directory manager 72 receives the telephone number search request on the call receiver side, including the receiver's user ID (step S77). The telephone directory manager 72 searches the telephone directory data table 76 by the receiver's user ID, reads out the telephone number on the call receiver side, and outputs the telephone number to the calling request processor 73 (step S79).

The calling request processor 73 receives the telephone number on the call receiver side from the telephone directory manager 72, and stores the received telephone number into a storage device such as the main memory (step S81). Then, it transmits, to the media management server 5, a calling request including the session ID, the telephone number on the calling side, which was received in the step S73, the telephone number on the call receiver side, which was received in the step S81, and the recording flag (ON) (step S83). In addition, it also transmits Web page data including a calling completion notice to the mobile phone A (step S87). The browser of the mobile phone A receives the web page data including the calling completion notice from the mobile connection server 7, and displays the data on the display device (step S89). For example, a screen as shown in FIG. 15 is displayed. In the screen example of FIG. 15, a message stating, “Calling has been completed” and the link to return to the TOP screen (top menu screen) are provided.

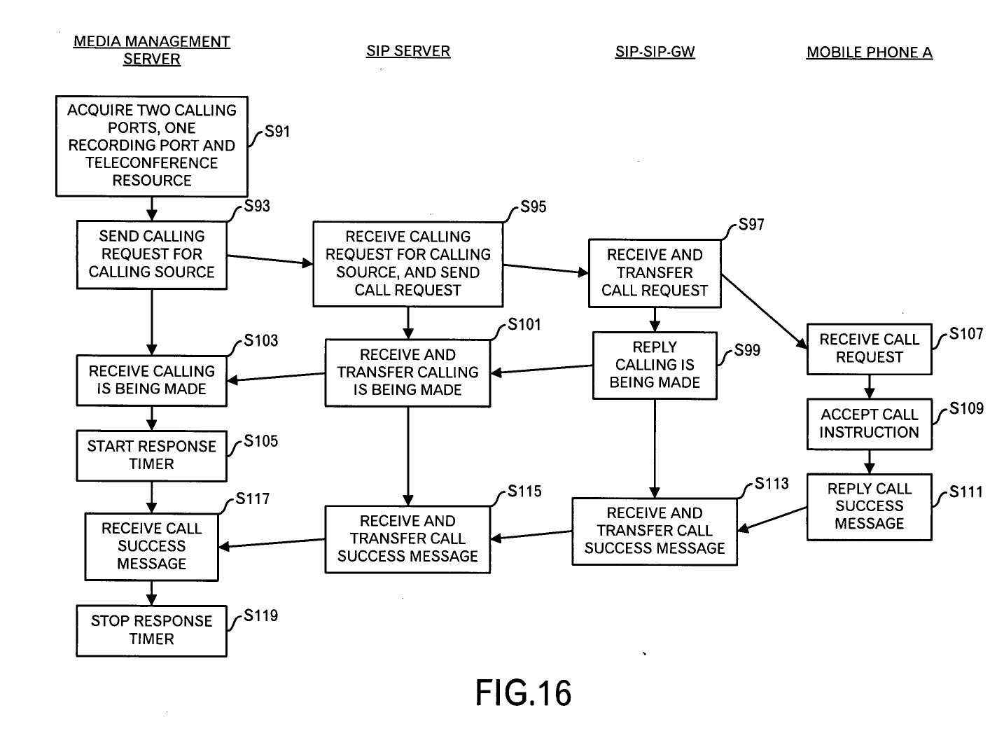

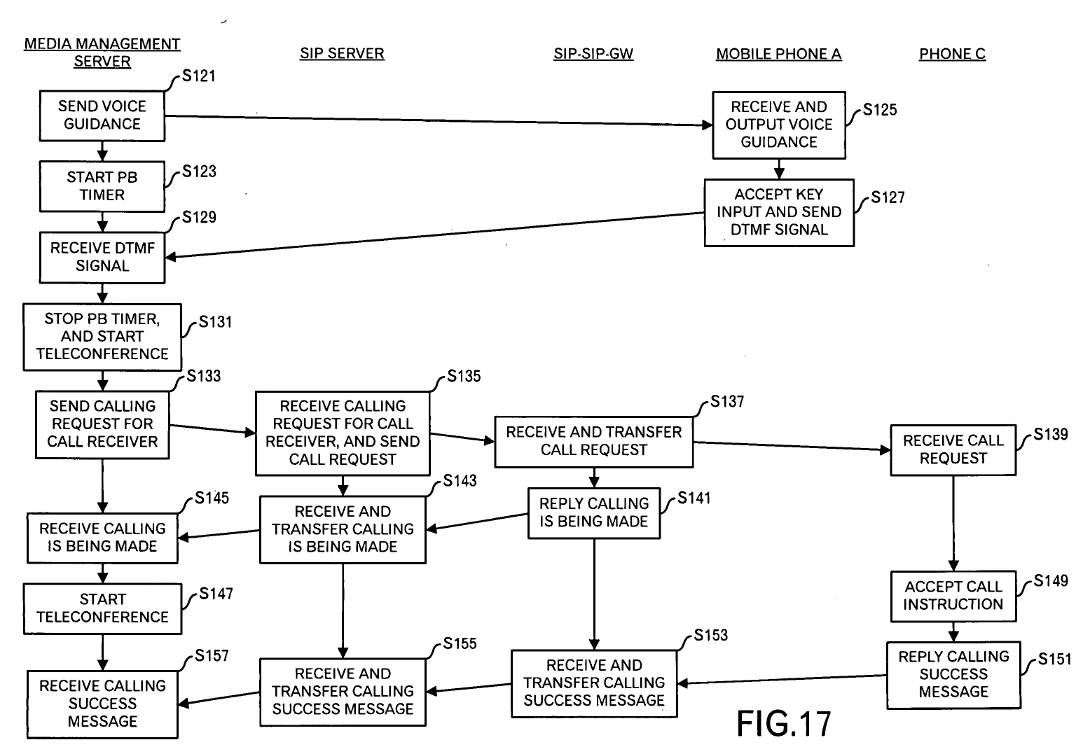

On the other hand, the media management server 5 receives, from the mobile connection server 7, the calling request including the session ID, the telephone number on the calling side, the telephone number on the call receiver side, and the recording flag (ON) (step S85). The subsequent processing will be described with reference to FIG. 16.

The description shifts to that of the processing of FIG. 16. In response to the calling request including the recording flag (ON), the media management server 5 acquires two calling ports, one recording port, and a teleconference resource to conduct a teleconference by connecting these ports (step S91). Incidentally, the recording port is unnecessary in case of the recording flag (OFF). Next, the media management server 5 transmits a calling request for a calling source, which includes the telephone number on the calling side and the telephone number assigned to the media management server 5 as caller's telephone number to the SIP server 9 (step S93). The SIP server 9 receives the calling request for the calling source, which includes the telephone number on the calling side and the telephone number assigned to the media management server 5 as the caller's telephone number from the media management server 5, and transmits a call request for the telephone number on the calling side to the SIP-SIP-GW 3 in response to the calling request (step S95).

The SIP-SIP-GW 3 receives the call request for the telephone number on the calling side, which includes the telephone number on the calling side and the telephone number assigned to the media management server 5 as the caller's telephone number, from the SIP server 9, and transfers the call request to the mobile phone A (step S97). Furthermore, it returns a message indicating that the call is being made to the SIP server 9 (step S99). The SIP server 9 receives the message indicating the call is being made from the SIP-SIP-GW 3, and transfers the message to the media management server 5 (step S101). The media management server 5 receives the message indicating the call is being made (step S103), and starts time measurement by a response timer (step S105).

The mobile phone A receives the call request from the SIP-SIP-GW 3 (step S107), and outputs a ring tone. Because the call request includes the telephone number assigned to the media management server 5 as the caller's telephone number, the mobile phone A displays the telephone number assigned to the media management server 5 as the caller's telephone number on the display device. When the user of the mobile phone A pushes a call button in response to this display, the mobile phone A accepts such a call instruction (step S109), and returns a call success message to the SIP-SIP-GW 3 (step S111). The SIP-SIP-GW 3 receives the call success message from the mobile phone A, and transfers the message to the SIP server 9 (step S113). Furthermore, the SIP server 9 receives the call success message from the SIP-SIP-GW 3, and transfers the message to the media management server 5 (step S115).

The media management server 5 receives the call success message from the SIP server 9 (step S117), and stops the time measurement by the response timer in response to the receipt of the call success message (step S119). There will be provided later a description of a case that the call success message is not received within a predetermined time. It is assumed here that the call success message is received within the predetermined time. By the processing up to this step, a link of the voice communication between the media management server 5 and the mobile phone A has been established, and it enables to exchange voice data with the mobile phone A via a first calling port. The subsequent processing will be described with reference to FIG. 17.

The description shifts to that of processing of FIG. 17. The media management server 5 transmits a voice guidance stating, “This is an incoming call from a telephone directory service. Please push “#” when you start” to the mobile phone A (step S121). Moreover, the time measurement starts by a push button (PB) timer in response to the transmission of the voice guidance (step S123). The mobile phone A receives the aforementioned voice guidance, and outputs the guidance from a speaker (step S125). Here, because the user of the mobile phone A is in a state capable of responding immediately, the user pushes the button “#”. The mobile phone A accepts the push of the key “#” by the user, and transmits a dial tone multi frequency (DTMF) signal (push button (PB) signal) of “#” (step S127).

The media management server 5 receives the DTMF signal of “#” from the mobile phone A (step S129). In this case, the time measurement by the PB timer is stopped, and it is judged whether or not the DTMF signal of “#” has been received within the predetermined time. It is assumed here that the DTMF signal of “#” is received within the predetermined time. Then, the teleconference is started with a first speaker (the user of the mobile phone A) by using the teleconference resource acquired in the step S91 (step S131). After that, the media management server 5 transmits, to the SIP server 9, the calling request for the call receiver, which includes the telephone number on the call receiver side and the telephone number assigned to the media management server 5 as the caller's telephone number (step S133). When receiving the calling request for the receiver, which includes the telephone number on the call receiver side and the telephone number assigned to the media management server 5 as the caller's telephone number, the SIP server 9 transmits, to the SIP-SIP-GW 3, a call request with respect to the telephone number on the call receiver side in response to the calling request (step S135).

The SIP-SIP-GW 3 receives the call request, which includes the telephone number on the call receiver side and the telephone number assigned to the media management server 5 as the caller's telephone number from the SIP server 9, and transfers the request to the phone C (step S137). Furthermore, the SIP-SIP-GW 3 returns a message including the call is being made to the SIP server 9 (step S141). The SIP server 9 receives the message indicating the call is being made from the SIP-SIP-GW 3, and transfers the message to the media management server 5 (step S143). The media management server 5 receives the message indicating the call in being made (step S145), and starts the teleconference with a second speaker (a user of the phone C) by using the teleconference resource acquired in the step S91 (step S147).

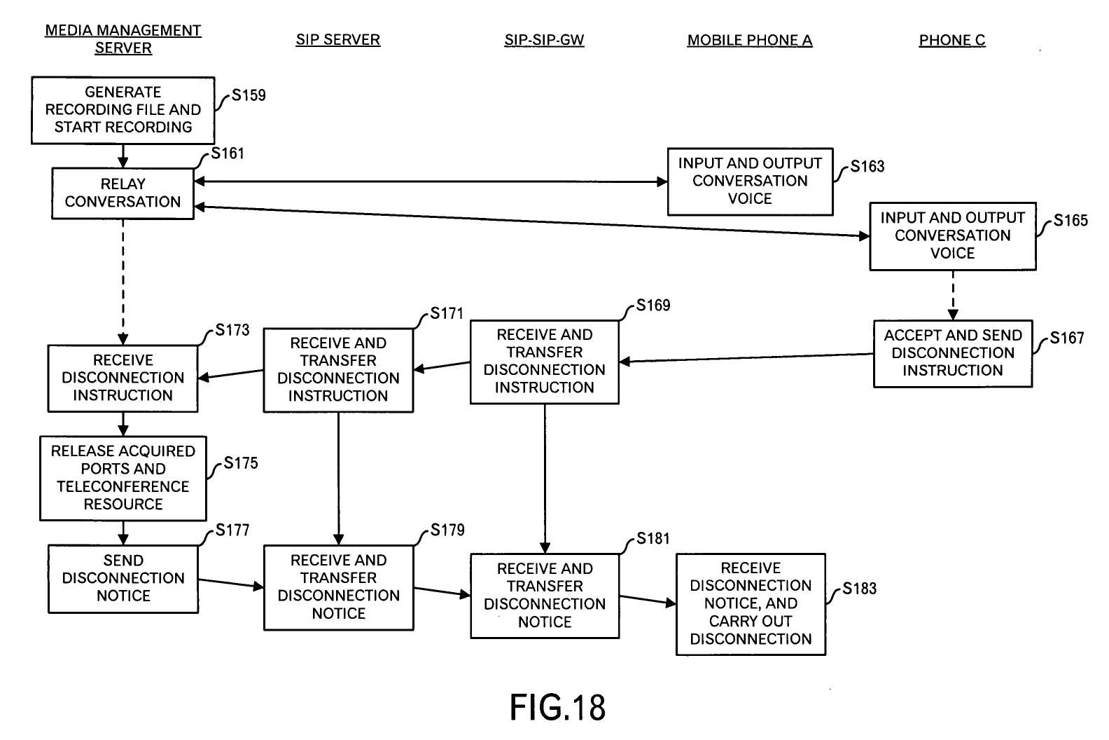

On the other hand, the phone C receives the call request from the SIP-SIP-GW 3 (step S139), and outputs the ringing tone. Because the call request includes the telephone number assigned to the media management server 5 as the caller's telephone number, the phone C displays the telephone number assigned to the media management server 5 as the caller's telephone number on the display device, if possible. When the user of the phone C picks up a phone receiver, or pushes a call button, the phone C accepts the call instruction (step S149), and returns the call success message to the SIP-SIP-GW 3 (step S151). The SIP-SIP-GW 3 receives the call success message from the phone C, and transfers the message to the SIP server 9 (step S153). Furthermore, the SIP server 9 receives the call success message from the SIP-SIP-GW 3, and transfers the message to the media management server 5 (step S155). The media management server 5 receives the call success message from the SIP server 9 (step S157). By the processing up to this step, a link of the voice communication between the media management server 5 and the phone C has been established, and it enables to exchange the voice data with the phone C via the second calling port. The subsequent processing will be described with reference to FIG. 18.

The description shifts to that of processing of FIG. 18. The media management server 5 generates a recording file, and starts the recording of a voice conversation (step S159). Then, the voice data from the mobile phone A and the phone C are relayed to another phone based on the teleconference function (step S161). The recording is simultaneously carried out. The mobile phone A receives a voice input from a microphone, transmits the voice data of the input voice to the media management server 5, receives the voice data from the media management server 5, and outputs the data from the speaker (step S163). The phone C similarly accepts the voice input from the microphone, transmits the voice data of the input voice to the media management server 5, receives the voice data from the media management server 5, and outputs the data from the speaker (step S165). The voice communication is carried out between the mobile phone A and the phone C in this manner.

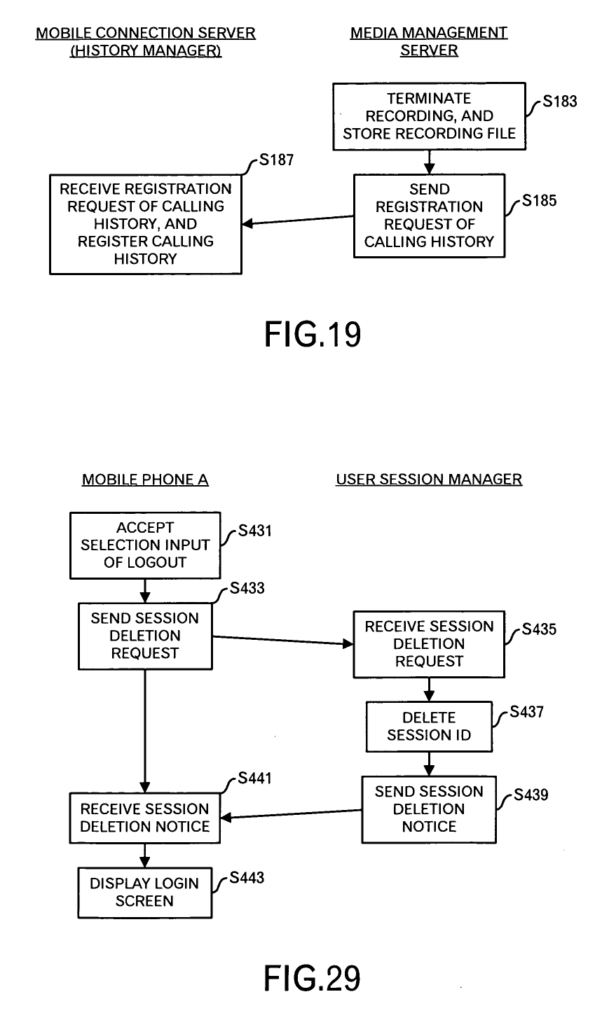

Next, a processing in disconnection will be described. Here, there will be provided a description of an example in which an instruction for the disconnection is issued from the user of the phone C. However, this also applies to the instruction from the user of the mobile phone A. First, when the user of the phone C hangs up or pushes a disconnection button, the phone C accepts the instruction for the disconnection from the user, and transmits the disconnection instruction to the SIP-SIP-GW 3 (step S167). The phone C disconnects the link with the media management server 5. When receiving the disconnection instruction from the phone C, the SIP-SIP-GW 3 transfers the disconnection instruction to the SIP server 9 (step S169). Furthermore, the SIP server 9 receives the disconnection instruction from the SIP-SIP-GW 3, and transfers the disconnection instruction to the media management server 5 (step S171). The media management server 5 receives the disconnection instruction from the SIP server 9 (step S173), and releases the ports and teleconference resource for the teleconference, which are acquired in the step S91 (step S175). Furthermore, the media management server 5 transmits, to the SIP server 9, a disconnection notice to the mobile phone A (step S177). The SIP server 9 receives the disconnection notice from the media management server 5, and transfers the disconnection notice to the SIP-SIP-GW 3 (step S179). Furthermore, the SIP-SIP-GW 3 receives the disconnection notice from the SIP server 9, and transfers the disconnection notice to the mobile phone A (step S181). The mobile phone A receives the disconnection notice from the SIP-SIP-GW 3, and disconnects the link with the media management server 5. The subsequent processing will be described with reference to FIG. 19.

The description shifts to that of the processing of FIG. 19. The media management server 5 terminates the recording, and stores the recording file into the recording data storage 51 (step S183). The recording file name is constituted as, for example, (date and time)—(mobile phone number). If necessary, the user of the mobile phone A can reproduce later the designated recording file stored in the recording data storage 51 by the media management server 5.

Moreover, the media management server 5 generates outgoing call history (calling source's telephone number, call receiver's telephone number, presence or absence of recording (present here), calling date and time, call start date and time, call end date and time, call time, and calling success code), and transmits a registration request of the outgoing call history to the history manager 74 of the mobile connection server 7 (step S185). The history manager 74 of the mobile connection server 7 receives the registration request of the outgoing call history from the media management server 5, stores the outgoing call history data into the history management data storage 77, and updates a history management data table by using the calling date and time, calling source's telephone number, and call receiver's telephone number (step S187).

Although the processing in the normal mode has been described above, because some of the messages according to SIP are not directly related to the present embodiment, such messages are omitted from the description. This also applies to the following description.

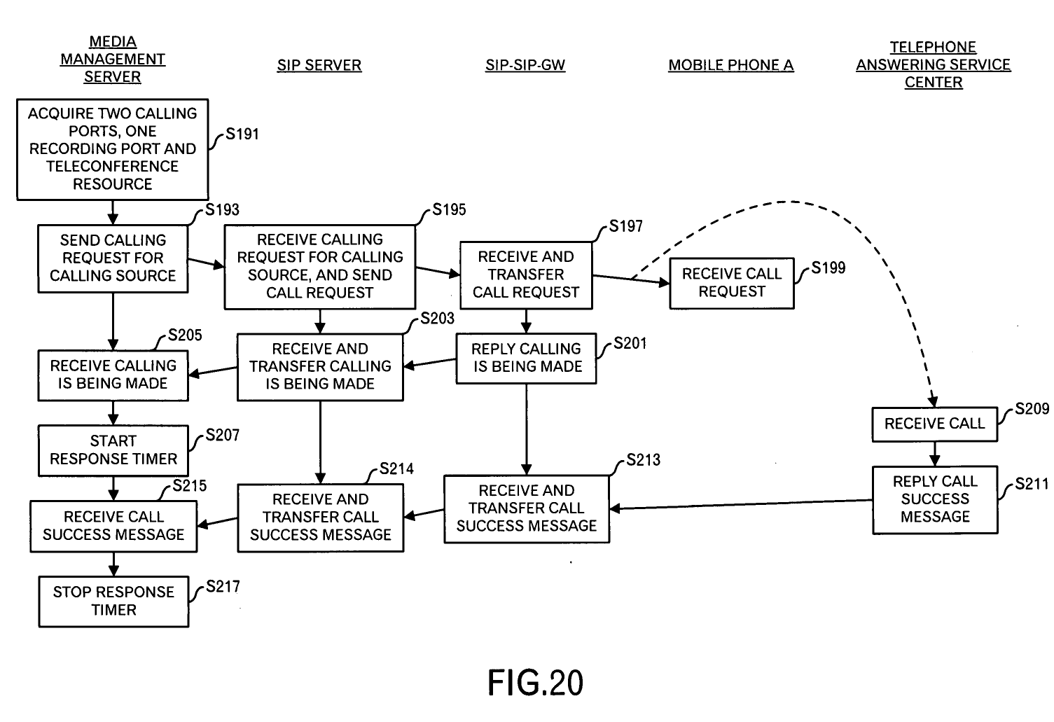

Next, there will be provided a description of a processing in a case where a calling request is issued from the mobile phone A, but the call conversation becomes impossible immediately after the calling request is issued because of a certain reason, with reference to FIGS. 20 to 22. Incidentally, because the processing before the step S91 is the same, the description is omitted. First, the media management server 5 acquires two calling ports, one recording port, and a teleconference resource to carry out the teleconference by connecting these ports in response to the calling request including a recording flag (ON) (step S191). Next, the server transmits a calling request for a calling source, which includes the telephone number on the calling source side and the telephone number assigned to the media management server 5 as the caller's telephone number, to the SIP server 9, (step S193). The SIP server 9 receives the calling request for the calling source, which includes the telephone number on the calling source side and the telephone number assigned to the media management server 5 as the caller's telephone number, from the media management server 5, and transmits the call request with respect to the telephone number on the calling source side to the SIP-SIP-GW 3 in response to the calling request (step S195).

The SIP-SIP-GW 3 receives the call request for the telephone number on the calling source side, which includes the telephone number on the calling source side and the telephone number assigned to the media management server 5 as the caller's telephone number, from the SIP server 9, and transfers the call request to the mobile phone A (step S197). Furthermore, the SIP-SIP-GW 3 returns a message indicating the calling is being made to the SIP server 9 (step S201). The SIP server 9 receives the message indicating the calling is being made from the SIP-SIP-GW 3, and transfers the call message to the media management server 5 (step S203). The media management server 5 receives the message indicating the calling is being made (step S205), and starts the time measurement by the response timer (step S207).

The mobile phone A receives the call request from the SIP-SIP-GW 3 (step S199), and outputs the ring tone. Because the call request includes the telephone number assigned to the media management server 5 as the caller's telephone number, the mobile phone A displays the telephone number assigned to the media management server 5 as the caller's telephone number on the display device. However, as described above, the user of the mobile phone A cannot pushes the call key, and the call request is transferred to a telephone answering service center via a known mechanism in the network 1 after elapse of a predetermined time.

When receiving the call request, as usual, the telephone answering service center carries out a receiving processing (step S209), and returns a call success message to the SIP-SIP-GW 3 (step S211). The SIP-SIP-GW 3 receives the call success message from the telephone answering service center, and transfers the call success message to the SIP server 9 (step S213). Furthermore, the SIP server 9 receives the call success message from the SIP-SIP-GW 3, and transfers the call success message to the media management server 5 (step S214).

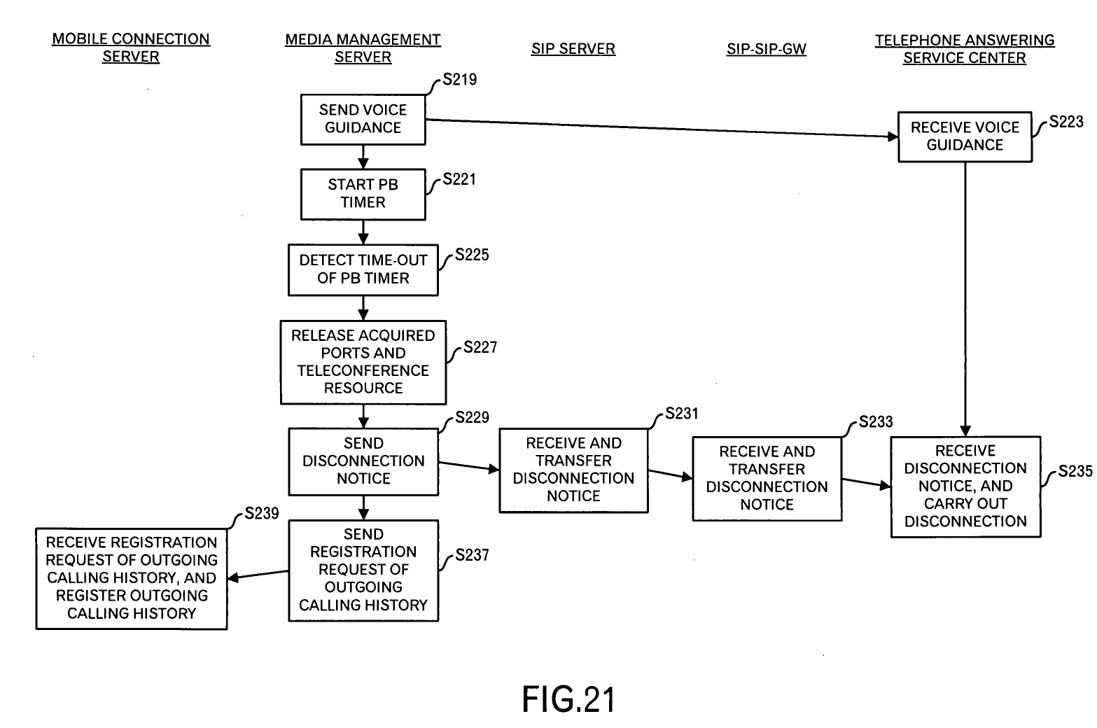

The media management server 5 receives the call success message from the SIP server 9 (step S215), and stops the time measurement by the response timer in response to receiving the call success message (step S217). It is also assumed here that the call success message is received within a predetermined time. By the processing up to this step, the link of the voice communication between the media management server 5 and the telephone answering service center has been established, and the exchange of the voice data with the telephone answering service center can be carried out through the first calling port. Incidentally, the telephone answering service center starts transmitting a predetermined voice message to the media management server 5 in one way. The subsequent processing will be described with reference to FIG. 21.

The description shifts to that of the processing of FIG. 21. The media management server 5 transmits, to the telephone answering service center, the voice guidance stating, “This is an incoming call from the telephone directory service. Please input “#” when you start” (step S219). The time measurement starts with the PB timer in response to the transmission of the voice guidance (step S221). The telephone answering service center receives the aforementioned voice guidance (step S223). However, because the telephone answering service center does not respond to the voice guidance, the DTMF signal of “#” is not sent.

That is, the time measurement by the PB timer results in time-out, and this time-out is detected (step S225). Then, the media management server 5 releases three ports and the teleconference resource acquired in the step S191 (step S227). Furthermore, it transmits a disconnection notice for the telephone answering service center to the SIP server 9 (step S229). The SIP server 9 receives the disconnection notice from the media management server 5, and transfers the disconnection notice to the SIP-SIP-GW 3 (step S231). Furthermore, the SIP-SIP-GW 3 receives the disconnection notice from the SIP server 9, and transfers the disconnection notice to the telephone answering service center (step S233). The telephone answering service center receives the disconnection notice from the SIP-SIP-GW 3, and disconnects the link with the media management server 5 (step S235).

Furthermore, the media management server 5 generates a calling history (calling source's telephone number, call receiver's telephone number, presence or absence of the recording (present), calling date and time, call start date and time (none), call end date and time (none) call time (none) and calling failure code), and transmits a registration request of the calling history to the history manager 74 of the mobile connection server 7 (step S237). The history manager 74 of the mobile connection server 7 receives the registration request of the calling history from the media management server 5, and stores the calling history into the history management data storage 77 (step S239). Incidentally, the history management data table is also updated.

Such a processing can appropriately terminate the communication, even if a situation in which the link is connected to the telephone answering service center occurs.

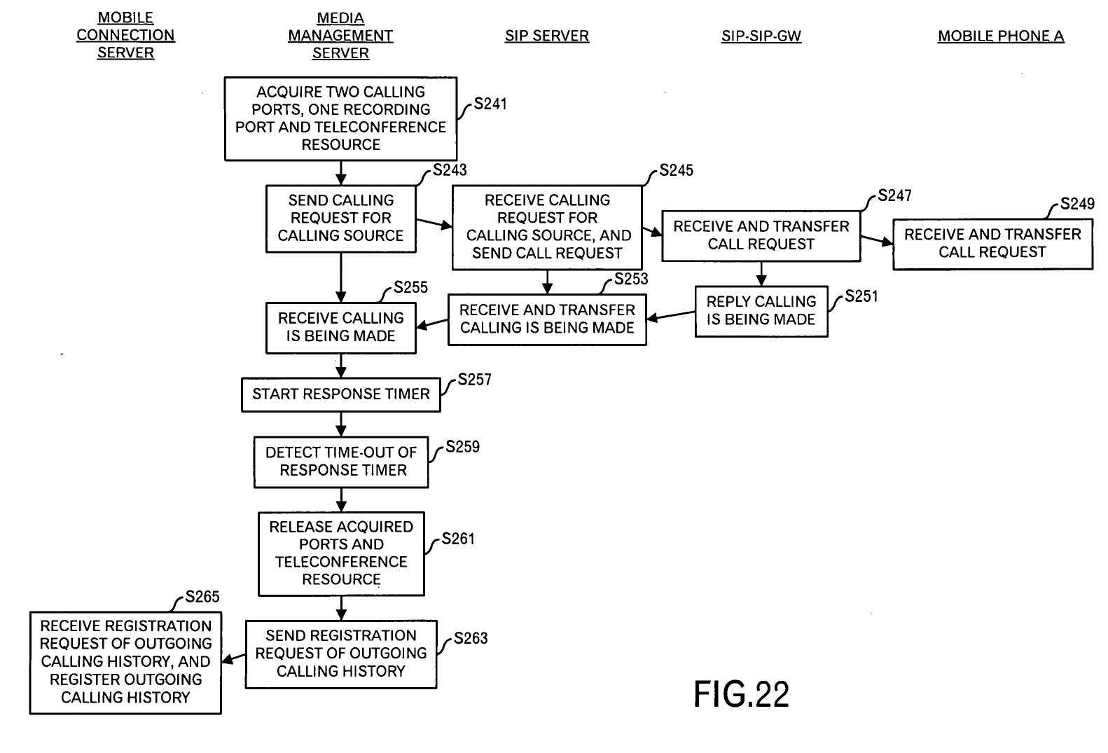

Next, there will be described processing in a case where the calling request is issued from the mobile phone A, but the call conversation cannot be made immediately after the calling request is issued for a certain reason, and the calling request is not transferred to the answering phone center, with reference to FIG. 22. Incidentally, because the processing before the step S91 is the same, the description is omitted.

First, the media management server 5 acquires two calling ports, one recording port, and the teleconference resource to carry out the teleconference by connecting these ports in the media management server 5 in response to the calling request including the recording flag (ON) (step S241). Next, the media management server 5 transmits the calling request for the calling source, which includes the telephone number on the calling source side and the telephone number assigned to the media management server 5 as the caller's telephone number, to the SIP server 9, (step S243). The SIP server 9 receives the calling request for the calling source, which includes the telephone number on the calling source and the telephone number assigned to the media management server 5 as the caller's telephone number, from the media management server 5, and transmits the call request for the telephone number on the calling source side to the SIP-SIP-GW 3 in response to the calling request (step S245).

The SIP-SIP-GW 3 receives the call request for the telephone number on the calling source side, which includes the telephone number on the calling source side and the telephone number assigned to the media management server 5 as the caller's telephone number, from the SIP server 9, and transfers the call request to the mobile phone A (step S247). Furthermore, it returns a message indicating the calling is being made to the SIP server 9 (step S251). The SIP server 9 receives the message indicating the calling is being made from the SIP-SIP-GW 3, and transfers the message to the media management server 5 (step S253). The media management server 5 receives the message indicating the calling is being made (step S255), and starts the time measurement by the response timer (step S257).

The mobile phone A receives the call request from the SIP-SIP-GW 3 (step S249), and outputs the ring tone. Because the call request includes the telephone number assigned to the media management server 5 as the caller's telephone number, the mobile phone A displays the telephone number assigned to the media management server 5 as the caller's telephone number on the display device. However, as described above, the user of the mobile phone A cannot press the call key. Therefore, the call success message is not indefinitely transmitted to the media management server 5.

Thus, the time measurement by the response timer results in time-out, and this time-out is detected (step S259). Then, the media management server 5 releases three ports and the teleconference resource acquired in the step S241 (step S261).

Furthermore, the media management server 5 generates the outgoing calling history (calling source's telephone number, call receiver telephone number, presence or absence of the recording (present), call date and time, call start date and time (none), call end date and time (none), call time (none), and calling failure code) and transmits a registration request of the outgoing calling history to the history manager 74 of the mobile connection server 7 (step S263). The history manager 74 of the mobile connection server 7 receives the registration request of the outgoing calling history from the media management server 5, stores the outgoing calling history into the history management data storage 77 (step S265), and also updates the history management data table.

Such a processing can appropriately terminate the communication even if a situation in which the user of the mobile phone A cannot respond and the telephone answering service center is not connected occurs.

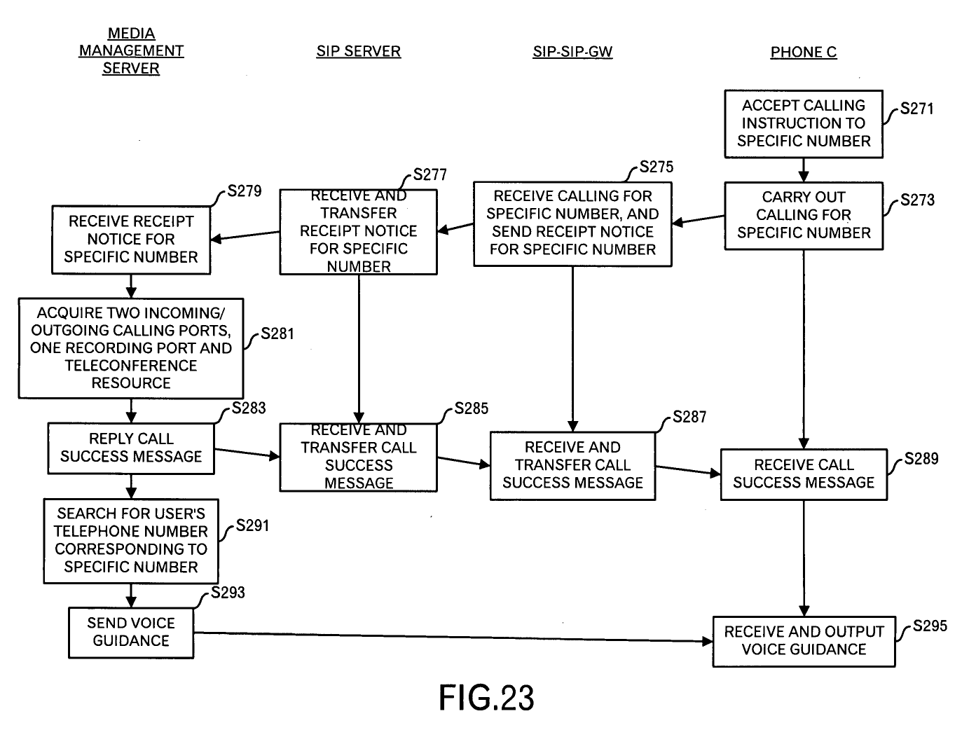

Next, there will be provided a description of a processing in a case where there is an incoming call from the phone (e.g., phone C) whose telephone number is not registered in the user information table 52, with reference to FIGS. 23 to 26.

First, the user of the phone C operates the phone C, and instructs the calling to a specific number (direct inward dial number of the user of the mobile phone B here). The phone C accepts a calling instruction to the specific number from the user (step S271), and carries out a calling to the specific number (step S273). Incidentally, a caller's telephone number is notified, and the telephone number of the phone C is notified to the media management server 5. For example, the calling from telephone C is transferred based on the specific number by an exchanger or the like in the network 2.

The SIP-SIP-GW 3 receives, from the phone C, the calling to the specific number, including the telephone number of the phone C as the caller's telephone number notice, and transmits, to the SIP server 9, a receipt notice for the specific number (step S275). The SIP server 9 receives, from the SIP-SIP-GW 3, the receipt notice for the specific number, and transfers the receipt notice to the media management server 5 (step S277). The media management server 5 receives, from the SIP server 9, the receipt notice for the specific number (step S279), and acquires two incoming/outgoing ports, one recording port, and the teleconference resource to carry out teleconference by connecting these ports in the media management server 5 in response to receiving the receipt notice (step S281). The teleconference starts with the first speaker (user of the phone C) by using the teleconference resource.

Then, the media management server 5 transmits the call success message to the SIP server 9 (step S283). The SIP server 9 receives the call success message from the media management server 5, and transfers the message to the SIP-SIP-GW 3 (step S285). The SIP-SIP-GW 3 receives the call success message from the SIP server 9, and transfers the message to the phone C (step S287). Furthermore, the phone C receives the call success message from the SIP-SIP-GW 3 (step S289). By the processing up to this step, the link of the voice communication has been established between the media management server 5 and the phone C through a first link.

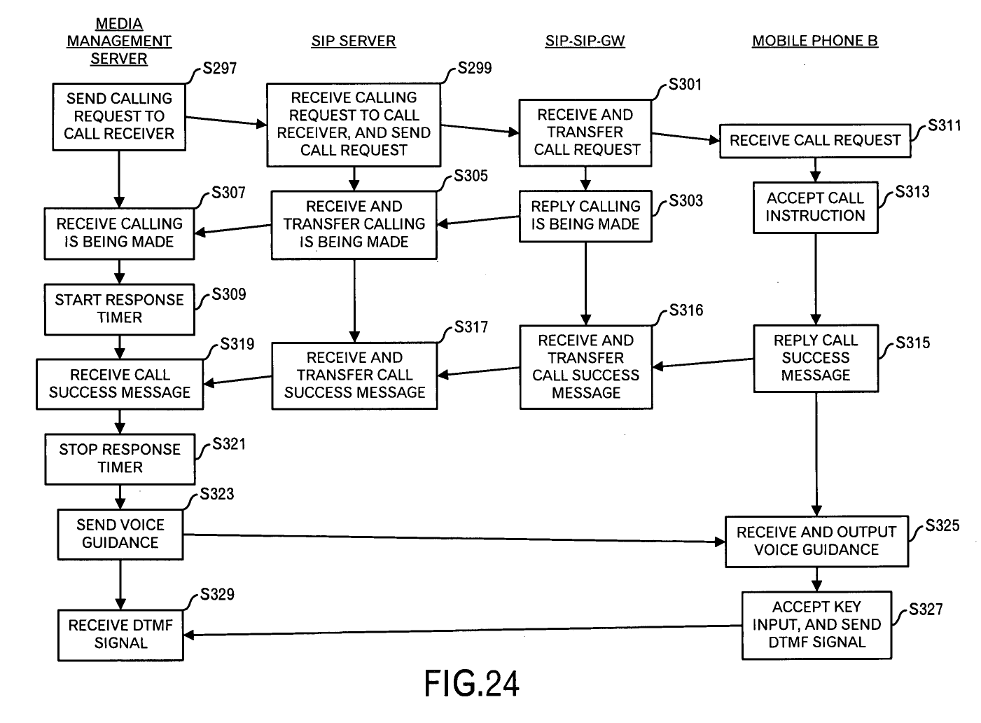

The media management server 5 searches the user information table by the specific number, separately from the step S283, and extracts the telephone number (telephone number of mobile phone B) of the user corresponding to the specific number (step S291). Then, it transmits a predetermined voice guidance to the phone C (step S293). The phone C receives the predetermined voice guidance from the media management server 5, and outputs the guidance from the speaker (step S295). The voice guidance is, for example, a message stating, “The person in charge of you is called just now, so please wait for a while”. The subsequent processing will be described with reference to FIG. 24.

The description shifts to that of the processing of FIG. 24. The media management server 5 transmits the calling request for the call receiver, which includes the telephone number of the call receiver (telephone number of the mobile phone B) and the telephone number assigned to the media management server 5 as the caller's telephone number, to the SIP server 9, (step S297). The SIP server 9 receives the calling request for the call receiver, which includes the telephone number of the call receiver and the telephone number assigned to the media management server 5 as the caller's telephone number, from the media management server 5, and transmits a call request for the telephone number of the call receiver to the SIP-SIP-GW 3 in response to the calling request (step S299).

The SIP-SIP-GW 3 receives the call request for the telephone number of the call receiver, which includes the telephone number of the call receiver and the telephone number assigned to the media management server 5 as the caller's telephone number, from the SIP server 9, and transfers the call request to the mobile phone B (step S301). Furthermore, it replies a message indicating the calling is being made to the SIP server 9 (step S303). The SIP server 9 receives the message indicating the calling is being made from the SIP-SIP-GW 3, and transfers the message to the media management server 5 (step S305). The media management server 5 receives the message indicating the calling is being made (step S307), and starts the time measurement by the response timer (step S309).

The mobile phone B receives the call request from the SIP-SIP-GW 3 (step S311), and outputs the ring tone. Because the call request includes the telephone number assigned to the media management server 5 as the caller's telephone number, the mobile phone B displays the telephone number assigned to the media management server 5 as the caller's telephone number on the display device. When the user of the mobile phone B pushes the call key in response to this display, the mobile phone B accepts the call receiving input (step S313), and returns the call success message to the SIP-SIP-GW 3 (step S315). The SIP-SIP-GW 3 receives the call success message from the mobile phone B, and transfers the message to the SIP server 9 (step S316). Furthermore, the SIP server 9 receives the call success message received from the SIP-SIP-GW 3, and transfers the message to the media management server 5 (step S317).

The media management server 5 receives the call success message from the SIP server 9 (step S319), and stops the time measurement by the response timer in response to receipt of the call success message (step S321). There will be provided later a description in a case where the call success message is not received within a predetermined time. It is assumed here that the call success message is received within the predetermined time. By the processing up to this step, the link of the voice communication between the media management server 5 and the mobile phone B has been established, and the exchange of the voice data with the mobile phone B is possible through the second calling port.

Moreover, the media management server 5 transmits, to the mobile phone B, the voice guidance stating, “This is an incoming call from XX-XXXX-XXX (telephone number of the phone C). Please input “1” when you start the call, input “2” when you record the call, and input “#” when you reject the call” (step S323). The time measurement starts with the PB timer in response to the transmission of the voice guidance. The mobile phone B receives the aforementioned voice guidance, and outputs the guidance from the speaker (step S325). Here, the user of the mobile phone B judges that he or she is in a state of being able to make an immediate response, and that the recording is necessary, and then presses a button“2”. The mobile phone B accepts the depression of the key “2” by the user and sends out the DTMF signal of “2” (step S327). The media management server 5 receives the DTMF signal of “2” from the mobile phone B (step S329). Then, the media management server 5 stops the time measurement by the PB timer, and judges whether or not the DTMF signal of “2” is received within the predetermined time. It is assumed here that the DTMF signal of “2” is received within the predetermined time. The teleconference with the second speaker (user of the mobile phone B) starts. There will be provided a description later in a case where the DTMF signal is not received within the predetermined time.

In this manner, the user of the mobile phone B does not have to talk with the user of the phone C immediately after the receipt of the call, and can make a conversation after the user becomes ready and presses the button designated by the voice guidance. Incidentally, because an original caller's (phone C) telephone number is notified by the voice guidance, it is possible to know from whom the phone received the call. In addition, according to such a method, there is no case in which the telephone number of the phone C, which is an original caller, is notified without notifying the telephone number assigned to the media management server 5 as the caller's telephone number. Therefore, any false telephone number of the caller is not given, and any legal problem does not occur. Furthermore, because the original caller is notified by the voice guidance, the caller's telephone number (phone C) does not remain in the mobile phone B, and the leakage of the information is prevented.

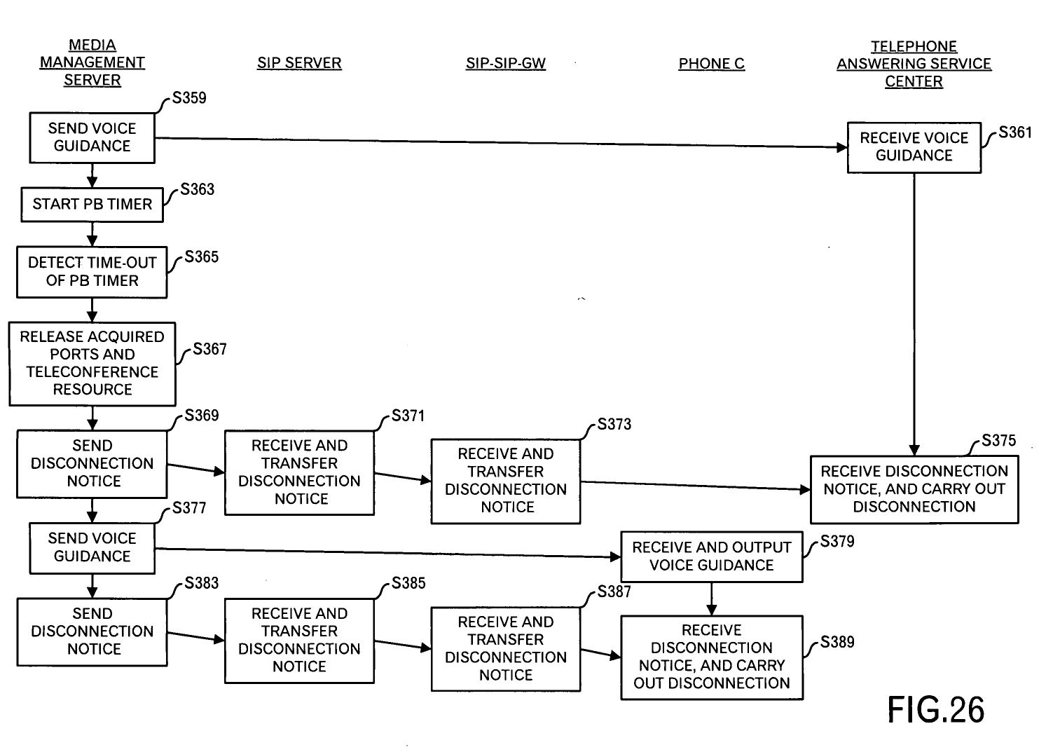

Because the subsequent processing is similar to that after the step S159 of FIG. 18, the description is omitted. Incidentally, when the key “1” is depressed on the mobile phone B, there is not any recording, and therefore, the processing of the recording by using the recording port is skipped. When the key “#” is depressed, the processing after step S377 (FIG. 26), which is described later, is carried out.

Moreover, although the telephone number of the phone C as the original caller is notified by the voice guidance, a client database may be searched in which a client name is registered in association with the telephone number of the client, as preprocessing, and the client name may be notified to the user of the mobile phone B instead of the telephone number.

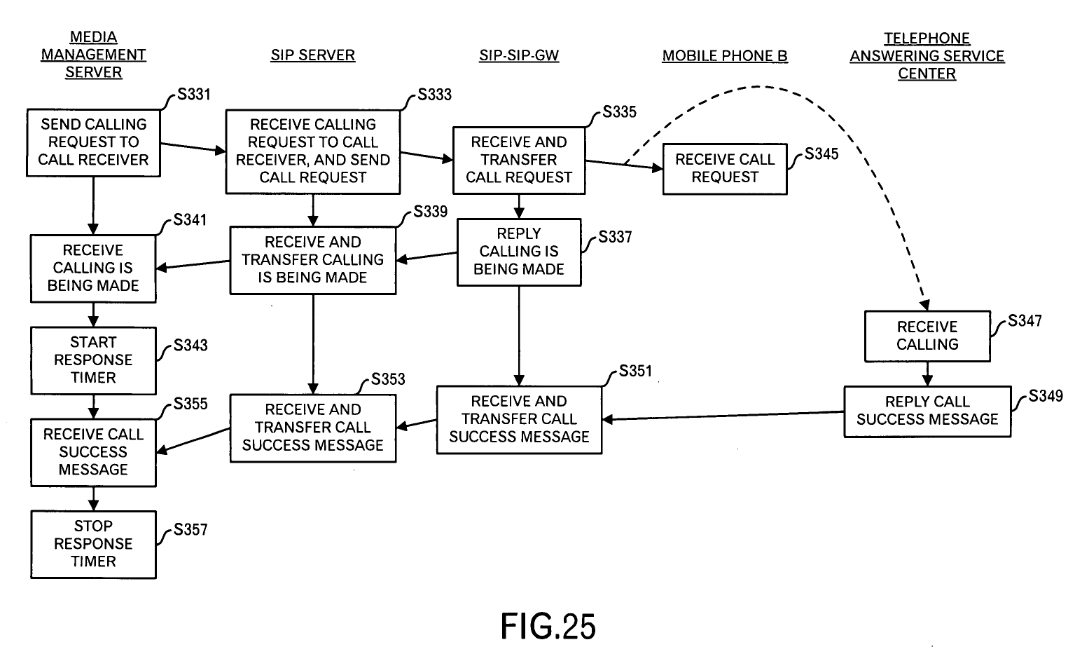

Next, there will be provided a description of a processing in a case where the mobile phone B cannot respond, with reference to FIGS. 25 and 26. Because the processing up to FIG. 23 is the same, the description is omitted.

First, the media management server 5 transmits, to the SIP server 9, the calling request for the call receiver, which includes the telephone number of the call receiver and the telephone number assigned to the media management server 5 as the caller's telephone number (step S331). The SIP server 9 receives the calling request for the call receiver, which includes the telephone number of the call receiver and the telephone number assigned to the media management server 5 as the caller's telephone number, from the media management server 5, and transmits a call request for the telephone number of the call receiver to the SIP-SIP-GW 3 in response to the calling request (step S333).

The SIP-SIP-GW 3 receives the call request for the telephone number of the call receiver, which includes the telephone number of the call receiver and the telephone number assigned to the media management server 5 as the caller's telephone numbers, from the SIP server 9, and transfers the call request to the mobile phone B (step S335). Furthermore, it replies the message indicating the calling is being made to the SIP server 9 (step S337). The SIP server 9 receives the message indicating the calling is being made from the SIP-SIP-GW 3, and transfers the message to the media management server 5 (step S339). The media management server 5 receives the message indicating the calling is being made (step S341), and starts the time measurement by the response timer (step S343).

The mobile phone B receives the call request from the SIP-SIP-GW 3 (step S345), and outputs the ring tone. Because the call request includes the telephone number assigned to the media management server 5 as the caller's telephone number, the mobile phone B displays the telephone number assigned to the media management server 5 as the caller's telephone number on the display device. However, as described above, the user of the mobile phone B cannot pushes the call key, and the call request is transferred to the telephone answering service center through a known mechanism in the network 1 after elapse of a predetermined time.

When receiving the call request, as usual, the telephone answering service center carries out the call receiving processing (step S347), and returns a call success message to the SIP-SIP-GW 3 (step S349). The SIP-SIP-GW 3 receives the call success message from the telephone answering service center, and transfers the call success message to the SIP server 9 (step S351). Furthermore, the SIP server 9 receives the call success message from the SIP-SIP-GW 3, and transfers the call success message to the media management server 5 (step S353).

The media management server 5 receives the call success message from the SIP server 9 (step S355), and stops the time measurement by the response timer in response to receipt of the call success message (step S357). It is also assumed here that the call success message is received within the predetermined time. By the processing up to this step, the link of the voice communication between the media management server 5 and the telephone answering service center has been established, and the exchange of the voice data with the telephone answering service center becomes possible through the second port. Incidentally, the telephone answering service center starts sending a predetermined voice message in one way. The subsequent processing will be described with reference to FIG. 26.

The description shifts to that of the processing of FIG. 26. The media management server 5 transmits, to the telephone answering service center, a voice guidance stating, “This is an incoming call from XX-XXXX-XXX (telephone number of the phone C). Please input “1” when you start the call, input “2” when you record the call, and input “#” when you reject the call” (step S359). The time measurement starts by the PB timer in response to the transmission of the voice guidance (step S363). The answering phone center receives the aforementioned voice guidance (step S361). However, because the telephone answering service center does not respond to the voice guidance, the designated DTMF signal is not sent out.

That is, the time measurement by the PB time results in time-out, and this time-out is detected (step S265). Then, the media management server 5 releases three ports and the teleconference resource acquired in the step S281 (step S367). Furthermore, it transmits a disconnection notice for the telephone answering service center to the SIP server 9 (step S369). The SIP server 9 receives the disconnection notice from the media management server 5, and transfers the disconnection notice to the SIP-SIP-GW 3 (step S371). Furthermore, the SIP-SIP-GW 3 receives the disconnection notice from the SIP server 9, and transfers the disconnection notice to the telephone answering service center (step S373). The telephone answering service center receives the disconnection notice from the SIP-SIP-GW 3, and disconnects the link with the media management server 5 (step S375).

Moreover, the media management server 5 transmits, to the phone C, a voice guidance stating, “We are very sorry, but we cannot connect” (step S377). The phone C receives the aforementioned voice guidance, and outputs the guidance through the speaker (step S379). Accordingly, the user of the phone C knows that the call cannot be made for a certain reason at present.

Furthermore, the media management server 5 transmits the disconnection notice for the phone C to the SIP server 9 (step S383). The SIP server 9 receives the disconnection notice from the media management server 5, and transfers the disconnection notice to the SIP-SIP-GW 3 (step S385). Furthermore, the SIP-SIP-GW 3 receives the disconnection notice from the SIP server 9, and transfers the disconnection notice to the phone C (step S387). The phone C receives the disconnection notice from the SIP-SIP-GW 3, and disconnects the link with the media management server 5 (step S389). In the subsequent processing, for example, the step S237 and S239 of FIG. 21 are executed.

By carrying out such a processing, the communication can be appropriately terminated, even if a situation in which the telephone answering service center is connected occurs.

Incidentally, in a case where the call is not transferred to the telephone answering service center, but the user of the mobile phone B does not answer the call, the processing stops at the step S345, and the time-out of the response timer is detected. Therefore, in such a case, the processing shifts to the step S377.

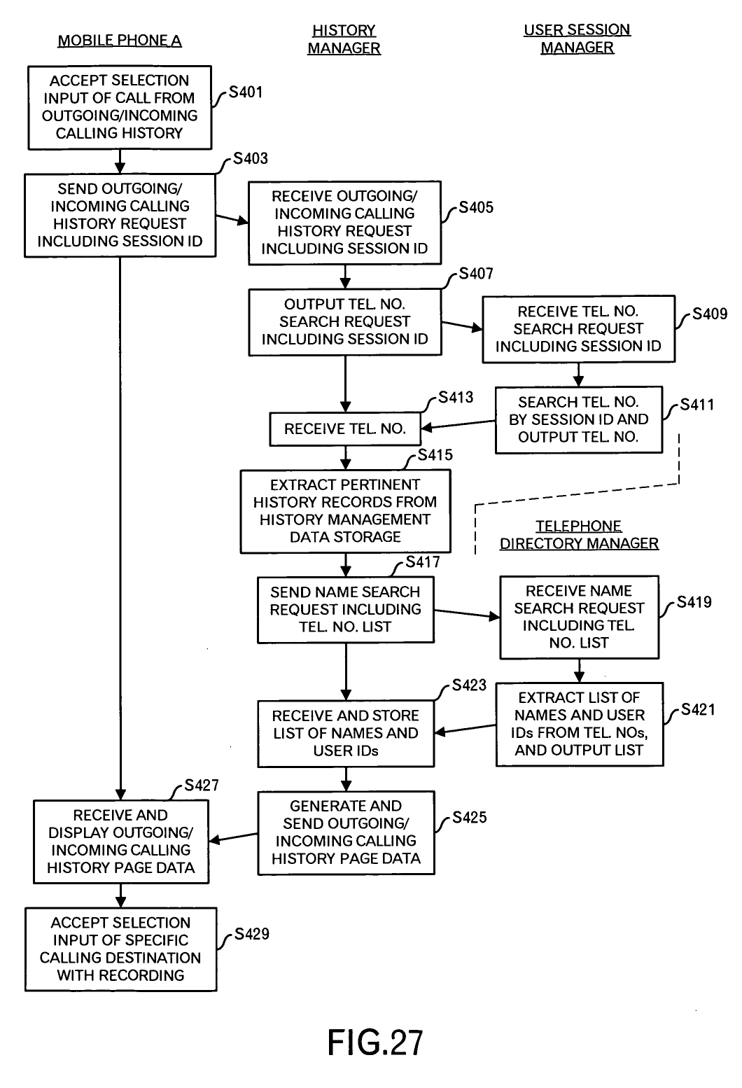

Next, there will be provided a description of a processing in a case where the “call from outgoing calling history” button or the “call from incoming calling history” button is clicked on the top menu screen, with reference to FIG. 27. First, the user of the mobile phone A clicks the “call from outgoing calling history” button or the “call from incoming calling history” button, and the mobile phone A accepts the selection input of “call from the outgoing calling history” or “call from incoming calling history” (step S401), and transmits the outgoing or incoming calling history request including the session ID to the mobile connection server 7 (step S403).

The history manager 74 of the mobile connection server 7 receives the outgoing or incoming calling history request including the session ID (step S405) from the mobile phone A, and outputs the telephone number search request including the received session ID to the user session manager 71 (step S407). The user session manager 71 receives the telephone number search request including the session ID (step S409) from the history manager 74, and searches the session management table 75 by the session ID, reads out the corresponding telephone number, and outputs the telephone number to the history manager 74 (step S411).

The history manager 74 receives the telephone number (telephone number of the mobile phone A) corresponding to the session ID from the user session manager 71 (step S413), and extracts a corresponding history record from the history management data storage 77 (step S415). In a case where the “call from outgoing calling history” is instructed, the history record is extracted in which the telephone number corresponding to the session ID is registered in the column of the caller's telephone number in the history management data table. In a case where “call from outgoing calling history” is instructed, the history record is extracted in which the telephone number corresponding to the session ID is registered in the column of the receiver's telephone number in the history management data table.

Then, the history manager 74 generates a telephone number list by using telephone numbers (telephone numbers other than the telephone number corresponding to the session ID) included in the corresponding history records, and outputs a name search request including the telephone number list to the telephone directory manager 72 (step S417). The telephone directory manager 72 receives the name search request including the telephone directory list from the history manager 74 (step S419), and searches the telephone directory data table 76 by the telephone numbers included in the telephone directory list to extract the corresponding names and user IDs. Then, the telephone directory manager 72 outputs a list of the names and user IDs to the history manager 74 (step S421).

The history manager 74 receives the list of the names and user IDs from the telephone directory manager 72, and stores the list into a storage device such as the main memory (step S423). Then, it generates outgoing or incoming calling history page data from the list of the names and user IDs and the history records extracted in the step S415, and transmits such page data to the mobile phone A (step S425).

The browser of the mobile phone A receives the outgoing or incoming calling history page data from the mobile connection server 7 and displays the data on the display device (step S427). For example, a screen shown in FIG. 28 is displayed. In the screen example of FIG. 28, a calling date column, a caller or receiver name column, call buttons corresponding to the history records without recording, and call buttons corresponding to the history records with recording are provided. The user ID itself is not displayed, and it is associated with the call button in the outgoing or incoming calling history page data together with the corresponding recording flag (ON/OFF).

The user of the mobile phone A clicks the call button corresponding to the client name of the calling destination. At this time, the user clicks the call button in the column with recording in a case where the recording is carried out, or clicks the call button in the column without recording in a case where the recording is not carried out. It is assumed here that the call button with recording is clicked with respect to the specific calling destination (here the phone C, but it may be the mobile phone B). Then, the browser of the mobile phone A accepts the selection input of the specific calling destination with recording (step S429). Because the subsequent processing is the same as that of FIG. 14, the description is omitted here.

Because the outgoing or incoming calling history does not remain in the mobile phone in the same manner as in case of the call from the telephone directory, the leakage of the information is prevented. Furthermore, because the web page data including client data with the user IDs with which the telephone number is substituted is transmitted to the mobile phone, the security is also improved in this respect.

Next, there will be provided a description of a processing in a case where “logout” is selected on the top menu screen, with reference to FIG. 29. First, when the user of the mobile phone A clicks a logout button, the mobile phone A accepts the selection input of the logout (step S431), and transmits a session deletion request including the session ID to the user session manager 71 of the mobile connection server 7 (step S433).

The user session manager 71 of the mobile connection server 7 receives the session deletion request including the session ID from the mobile phone A (step S435), searches the session management table 75 by the session ID, deletes the session ID from the pertinent record (step S437), and transmits a session deletion notice to the mobile phone A (step S439). Alternatively, login page data is transmitted.

The browser of the mobile phone A receives the session deletion notice from the mobile connection server 7 (step S441), and displays the login screen (FIG. 7) on the display device (step S443). Moreover, the browser discards the session ID, which it held. In this manner, the state of the browser returns to a state before the login.

According to the aforementioned processing, it is not necessary to register the client telephone number or the like in the mobile phone. In addition, even if the mobile phone falls into the hands of anyone else by robbery or the like, information such as the client telephone number does not leak. Because the client telephone number is not notified as data other than voice data to the mobile phone, information such as the client telephone number does not remain in the mobile phone, unless intended. Furthermore, because information is transmitted from the media management server 5, it is not necessary any more to divide a telephone rate even if the mobile phone itself belongs to an individual, and it enables to reduce an administrative work load.

Furthermore, because the call is not simply transferred, usability is improved for the client and the user in that the call can be started at the time when preparations are made in incoming call from the client or the like, the recording becomes possible, and the call can be appropriately terminated even if the incoming call switches to the answering machine.

Although the embodiment of the present invention has been described above, the present invention is not limited to this embodiment. That is, the functional blocks shown in FIG. 1 do not necessarily correspond to actual program modules. Furthermore, the server configuration indicated is also an example, and it is possible to adopt a method of realizing the invention using more servers by further dividing functions in charge, and the servers maybe further integrated.

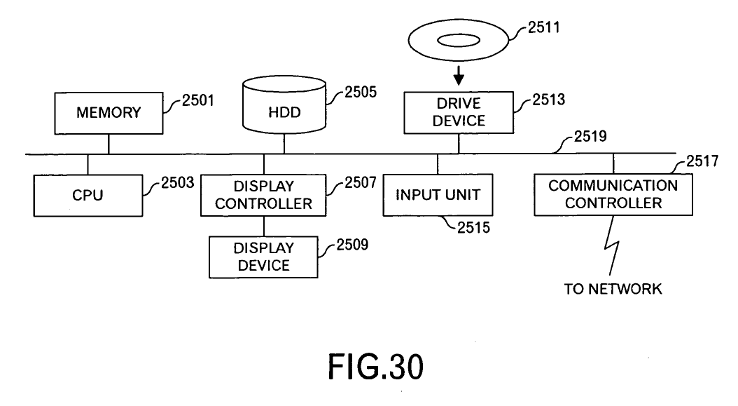

In addition, the SIP-SIP-GW 3, the media management server 5, the mobile connection server 7, the SIP server 9 and the like are computer devices as shown in FIG. 30. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information processing method, comprising:
receiving a request for data to select a calling destination from a first mobile phone capable of executing voice communication and data communication;
identifying calling destination candidates registered in a data storage in association with a user of said first mobile phone by identification information other than telephone numbers of said calling destination candidates; and
transmitting data to specify and select anyone of the identified calling destination candidates by said identification information other than said telephone numbers of said calling destination candidates, to said first mobile phone.

2. The information processing method as set forth in claim 1, wherein said request for data is a request for telephone directory data, and said data storage is a telephone directory data storage.

3. The information processing method as set forth in claim 1, wherein said request for data is a request for an incoming calling history data or an outgoing calling history data, and said data storage is a history data storage.

4. The information processing method as set forth in claim 1, further comprising:
receiving a call request including identification information of a specified calling destination and a recording request from said first mobile phone by said data communication;
securing a first port to carry out voice communication with said first mobile phone, a second port to carry out voice communication with a second phone relating to the specified calling destination, and a third port for recording;
establishing a link for said voice communication with said first mobile phone to carry out said voice communication via said first port;
establishing a link for said voice communication with said second phone to carry out said voice communication via said second port;
relaying voice data received from said first mobile phone to said second phone via said first port, and relaying said voice data received from said second phone to said first mobile phone via said second port; and
recording said voice data transmitted via said first said second ports by said third port.

5. The information processing method as set forth in claim 4, further comprising:
identifying a telephone number of said first mobile phone by using a session management table based on a session with said first mobile phone; and
identifying a telephone number of said second phone relating to the specified calling destination by using a telephone directory data storage based on identification information of the specified calling destination.

6. The information processing method as set forth in claim 4, wherein said establishing a link for said voice communication with said second phone to carry out said voice communication via said second port is carried out in response to receiving a predetermined Dial Tone Multi Frequency (DTMF) signal from said first mobile phone.

7. An information processing method, executed by a computer, to which a specific telephone number is assigned, comprising:
receiving a calling to a direct inward dial number, from a first phone;
establishing a link of voice communication with said first phone;
identifying a transfer destination telephone number corresponding to said direct inward dial number by using a user information table;
carrying out a calling from said specific telephone number to a transfer destination telephone number;
receiving acknowledgment of call receipt from said second phone relating to said transfer destination telephone number;
establishing a link for said voice communication with said second phone in response to receiving said acknowledgment of said call receipt; and
transmitting a guidance including information concerning a calling source as voice data to said second phone.

8. The information processing method as set forth in claim 7, wherein said guidance includes a message requesting a predetermined Dial Tone Multi Frequency (DTMF) signal to be replayed when said voice communication will be carried out with said first phone, and
said information processing method further comprising:
receiving said predetermined DTMF signal from said second phone; and
relaying voice data received from said first phone to said second phone, and relaying voice data received from said second phone to said first phone in response to receiving said predetermined DTMF signal.

9. The information processing method as set forth in claim 8, further comprising:
detecting a state in which said predetermined DTMF signal is not received within a predetermined time after said transmitting said guidance;
transmitting a guidance indicating inaccessibility of said voice data to said first phone after said detecting; and
disconnecting said link for said voice communication with said first phone.

10. The information processing method as set forth in claim 7, wherein said information concerning said calling source is a telephone number notified from said first phone, or a client name identified from a client database in which said client name is registered in association with said telephone number.

11. The information processing method as set forth in claim 7, further comprising:
detecting a state in which said acknowledgment of said call receipt is not received from said second phone relating to said transfer destination telephone number within a predetermined period;
transmitting a guidance indicating inaccessibility of said voice data to said first phone after said detecting;
disconnecting said link for said voice communication with said first phone.

12. The information processing method as set forth in claim 7, further comprising:
after said receiving said calling, securing securing a first port to carry out said voice communication with said first phone, a second port to carry out said voice communication with said second phone, and a third port for recording, and
wherein said voice communication with said first phone is carried out by using said first port, and said voice communication with said second phone is carried out by using said second port, and
said information processing method further comprises:
recording voice data communicated via said first and second ports by using said third port.

13. A program embodied on a medium, comprising:
receiving a request for data to select a calling destination from a first mobile phone capable of executing voice communication and data communication;
identifying calling destination candidates registered in a data storage in association with a user of said first mobile phone by identification information other than telephone numbers of said calling destination candidates; and
transmitting data to specify and select anyone of the identified calling destination candidates by said identification information other than said telephone numbers of said calling destination candidates, to said first mobile phone.

14. A program embodied on a medium, comprising:
receiving a calling to a direct inward dial number, from a first phone;
establishing a link of voice communication with said first phone;
identifying a transfer destination telephone number corresponding to said direct inward dial number by using a user information table;
carrying out a calling from said specific telephone number to a transfer destination telephone number;
receiving acknowledgment of call receipt from said second phone relating to said transfer destination telephone number;
establishing a link for said voice communication with said second phone in response to receiving said acknowledgment of said call receipt; and
transmitting a guidance including information concerning a calling source as voice data to said second phone.

15. A connection management server, comprising:
a unit that receives a request for data to select a calling destination from a first mobile phone capable of executing voice communication and data communication;
a unit that identifies calling destination candidates registered in a data storage in association with a user of said first mobile phone by identification information other than telephone numbers of said calling destination candidates; and
a unit that transmits data to specify and select anyone of the identified calling destination candidates by said identification information other than said telephone numbers of said calling destination candidates, to said first mobile phone.

16. A computer system, comprising:
a media management server; and
said connection management server as set forth in claim 15, and
wherein said connection management server further comprises:
a unit that receives a call request including identification information of a specified calling destination and a recording request from said first mobile phone by said data communication;
a unit that identifies a telephone number of said first mobile phone by using a session management table based on a session with said first mobile phone;
a unit that identifies a telephone number of said second phone relating to the specified calling destination by using a telephone directory data storage based on identification information of the specified calling destination; and
a unit that transmits a calling request including the identified telephone number of said first mobile phone as a calling source, the identified telephone number of said second phone as a calling destination, and a recording instruction to said media management server, and
wherein said media management server comprises:
a unit that secures a first port to carry out voice communication with said first mobile phone, a second port to carry out voice communication with a second phone relating to the specified calling destination, and a third port for recording in response to said calling request;
a unit that establishes a link for said voice communication with said first mobile phone to carry out said voice communication via said first port;
a unit that establishes a link for said voice communication with said second phone to carry out said voice communication via said second port;
a unit that relays voice data received from said first mobile phone to said second phone via said first port, and relaying said voice data received from said second phone to said first mobile phone via said second port; and
a unit that records said voice data transmitted via said first and second ports by said third port.

17. A computer system, to which a specific telephone number is assigned, comprising:
a unit that receives a calling to a direct inward dial number, from a first phone;
a unit that establishes a link of voice communication with said first phone;
a unit that identifies a transfer destination telephone number corresponding to said direct inward dial number by using a user information table;
a unit that carries out a calling from said specific telephone number to a transfer destination telephone number;
a unit that receives acknowledgment of call receipt from said second phone relating to said transfer destination telephone number;
a unit that establishes a link for said voice communication with said second phone in response to receiving said acknowledgment of said call receipt; and
a unit that transmits a guidance including information concerning a calling source as voice data to said second phone.

18. The computer system as set forth in claim 17, wherein said guidance includes a message requesting a predetermined Dial Tone Multi Frequency (DTMF) signal to be replayed when said voice communication will be carried out with said first phone, and
wherein said computer system further comprises:
a unit that receives said predetermined DTMF signal from said second phone; and
a unit that relays voice data received from said first phone to said second phone, and relaying voice data received from said second phone to said first phone in response to receiving said predetermined DTMF signal.

19. The computer system as set forth in claim 17, further comprising:
a unit that detects a state in which said predetermined DTMF signal is not received within a predetermined time after said transmitting said guidance;
a unit that transmits a guidance indicating inaccessibility of said voice data to said first phone after said detecting; and
a unit that disconnects said link for said voice communication with said first phone.
